(19) United States
(12) Patent Application Publication
(10) Pub. No.: US 2025/0093636 A1
(43) Pub. Date: Mar. 20, 2025

(54) HYPER-HEISENBERG SCALING QUANTUM MICROSCOPY

(71) Applicant: California Institute of Technology, Pasadena, CA (US)

(72) Inventors: Lihong Wang, Arcadia, CA (US); Xin Tong, Pasadena, CA (US); Zhe He, Pasadena, CA (US); Yide Zhang, Pasadena, CA (US)

(21) Appl. No.: 18/892,277

(22) Filed: Sep. 20, 2024

Related U.S. Application Data
(60) Provisional application No. 63/539,554, filed on Sep. 20, 2023.

(51) Int. Cl. G02B 21/36; G02B 21/00; G02B 21/06

(52) U.S. Cl. CPC G02B 21/361; G02B 21/002; G02B 21/06; G02B 21/367

(57) ABSTRACT

Hyper-Heisenberg scaling quantum imaging techniques that pass an idler photon of each entangled photon pair three times through an idler objective pair and pass a signal photon of each entangled photon pair at least once through a signal objective pair and use measurements of coincidence detection to yield a coincidence image with spatial resolution of about four times that of classical imaging.

### CROSS-REFERENCES TO RELATED APPLICATION

This application claims priority to and benefit of U.S. Provisional Patent Application No. 63/539,554, titled “Hyper-Heisenberg Limit Quantum Microscopy,” filed on Sep. 20, 2023,which is hereby incorporated by reference in its entirety and for all purposes.

### FEDERALLY SPONSORED RESEARCH OR DEVELOPMENT

This invention was made with government support under Grant No(s). CA220436 & EB028277 awarded by the National Institutes of Health. The government has certain rights in the invention.

### FIELD

Certain aspects generally relate to quantum super-resolution imaging techniques, and more specifically to hyper-Heisenberg scaling quantum microscopy and other hyper-Heisenberg scaling quantum imaging techniques.

### BACKGROUND

Since the inception of optical microscopy, there has been a sustained drive to resolve finer structures within microscopic objects. The spatial resolution of even a perfect optical imaging system is classically limited by diffraction, which depends on the optical wavelength and the numerical aperture (NA) of the collection optics. The emergence of entangled photon sources has catalyzed breakthroughs in quantum metrology where entanglement among N photons has been used to enhance accuracy by N times, sometimes reaching the Heisenberg scaling (HS). For example, using an N-photon entangled “NOON” state has produced an interference pattern N times finer than a classical state, and a spontaneous parametric down-conversion (SPDC) source has led to the HS. In quantum metrology, breaking the HS has been demonstrated experimentally using either nonlinear interaction (e.g., the Kerr effect) or multiple replicas of the object. However, HS has not been surpassed in metrology without using inefficient nonlinearity or impractical replication of the object, nor has HS been surpassed in imaging using any method.

### SUMMARY

Certain aspects pertain to hyper-Heisenberg scaling quantum imaging systems. In some aspects, a hyper-Heisenberg scaling quantum imaging system includes an entangled photon source (e.g., a spontaneous parametric down-conversion source) for generating a plurality of entangled photon pairs wherein each entangled photon pair is split into an idler photon and a signal photon. The hyper-Heisenberg scaling quantum imaging system also includes an idler arm optical assembly configured to pass the idler photon of each entangled photon pair in one or more passes through an idler objective pair and a signal arm optical assembly configured to pass the signal photon of each entangled photon pair at least once through an object plane of a signal objective pair. The hyper-Heisenberg scaling quantum imaging system also includes a detector (e.g., electron multiplying charge-coupled device) configured for coincidence detection of the idler photon and signal photon of each entangled photon pair to acquire a plurality of coincidence measurements. In one aspect, the hyper-Heisenberg scaling quantum imaging system further includes one or more beam-splitting elements configured to split each entangled photon pair into the idler photon and the signal photon.

Certain aspects pertain to hyper-Heisenberg scaling quantum imaging methods. In some cases, a hyper-Heisenberg scaling quantum imaging method includes generating a plurality of entangled photon pairs and splitting each entangled photon pair into an idler photon and a signal photon. The method also includes passing the idler photon of each entangled photon pair in one or more passes through an idler objective pair and passing the signal photon of each entangled photon pair at least once through a signal objective pair. The method also includes taking a plurality of coincidence measurements based on coincidence detection of signal photons from the signal arm and idler photons from the idler and determining a coincidence image based on the plurality of coincidence measurements. In one aspect, the method further includes reconstructing a plurality of frames from the plurality of coincidence measurements, registering a signal image and an idler image of each frame, calculating pixel-to-pixel covariances of the registered signal image of each of the plurality of frames, and determining the coincidence image from the pixel-to-pixel covariances.

In some other cases, a hyper-Heisenberg scaling quantum imaging method includes causing generation of a plurality of entangled photon pairs, wherein each entangled photon pair is split into an idler photon and a signal photon. The method also includes causing an idler photon of each entangled photon pair to be transmitted in one or more passes through an idler objective pair, wherein the signal photon of each entangled photon pair is transmitted at least once through a signal objective pair. The method also includes taking a plurality of coincidence measurements based on coincidence detection of signal photons from the signal arm and idler photons from the idler arm and determining a coincidence image based on the plurality of coincidence measurements. In one other case, the method also reconstructing a plurality of frames from the plurality of coincidence measurements, registering the signal and idler images of each frame, calculating pixel-to-pixel covariances of the registered signal image of each of the plurality of frames, and determining the coincidence image from the pixel-to-pixel covariances.

These and other features are described in more detail below with reference to the associated drawings.

### BRIEF DESCRIPTION OF THE DRAWINGS

Certain aspects are illustrated by way of example and not limitation in the figures of the accompanying drawings in which like references indicate similar elements.

FIG. 1 depicts a classical imaging (CI) imaging configuration using singles counts of photons, according to embodiments.

FIG. 2 depicts a 2-fold quantum super-resolution (SR2) imaging configuration for resolving at the Heisenberg scaling through coincidence detection with a single-pass idler arm, according to embodiments.

FIG. 3 depicts a 4-fold quantum super-resolution imaging (SR4) configuration for resolving at a hyper-Heisenberg scaling through coincidence detection of entangled photon pairs with a triple-pass idler arm, according to embodiments.

FIG. 4 depicts a block diagram of components of a hyper-Heisenberg scaling quantum imaging system, according to various embodiments.

FIG. 5 depicts a schematic drawing of components of a hyper-Heisenberg scaling quantum imaging system, according to embodiments.

FIG. 6A depicts plots of examples of polarization-state transformations in the idler arm of hyper-Heisenberg scaling quantum imaging system for a single-pass configuration, according to embodiments.

FIG. 6B depicts plots of examples of polarization-state transformations in the idler arm of hyper-Heisenberg scaling quantum imaging system for a triple-pass configuration, according to embodiments.

FIG. 7A depicts a plot of the lateral spatial resolutions along y versus z for the CI, SR2, and SR4 configurations of the hyper-Heisenberg scaling quantum imaging system in FIG. 5, according to an embodiment.

FIG. 7B depicts a plot of the edge spread function and line spread function of CI images yielded by the hyper-Heisenberg scaling quantum imaging system in FIG. 5, according to an embodiment.

FIG. 7C depicts a plot of the edge spread function and line spread function of SR2 images yielded by the hyper-Heisenberg scaling quantum imaging system in FIG. 5, according to an embodiment.

FIG. 7D depicts a plot of the edge spread function and line spread function of SR4 images yielded by the hyper-Heisenberg scaling quantum imaging system in FIG. 5, according to an embodiment.

FIG. 8A depicts a plot of the edge spread function and line spread function, along x, of CI images yielded by the hyper-Heisenberg scaling quantum imaging system in FIG. 5, according to an embodiment.

FIG. 8B depicts a plot of the edge spread function and line spread function, along x, of SR2 images yielded by the hyper-Heisenberg scaling quantum imaging system in FIG. 5, according to an embodiment.

FIG. 8C depicts a plot of the edge spread function and line spread function, along x, of SR4 images yielded by the hyper-Heisenberg scaling quantum imaging system in FIG. 5, according to an embodiment.

FIG. 8D depicts a plot of the edge spread function and line spread function, along y, of CI images yielded by the hyper-Heisenberg scaling quantum imaging system in FIG. 5, according to an embodiment.

FIG. 8E depicts a plot of the edge spread function and line spread function, along y, of SR2 images yielded by the hyper-Heisenberg scaling quantum imaging system in FIG. 5, according to an embodiment.

FIG. 8F depicts a plot of the edge spread function and line spread function, along y, of SR4 images yielded by the hyper-Heisenberg scaling quantum imaging system in FIG. 5, according to an embodiment.

FIG. 9A depicts a ground-truth image of the number “4” in group 3 of the USAF target (number 4 of USAF target) acquired using white-light optical microscopy under 40× magnification.

FIG. 9B depicts a CI image of number 4 of USAF target acquired with the hyper-Heisenberg scaling quantum imaging system in FIG. 5, according to an embodiment.

FIG. 9C depicts an SR2 image of number 4 of USAF target acquired with the hyper-Heisenberg scaling quantum imaging system in FIG. 5, according to an embodiment.

FIG. 9D depicts an SR4 image of the number 4 of USAF target acquired with the hyper-Heisenberg scaling quantum imaging system in FIG. 5, according to an embodiment.

FIG. 10A depicts a plot of contrast-to-noise ratios of the x profiles versus y, according to embodiments.

FIG. 10B depicts a plot of normalized CS, SR2, and SR4 counts along the dashed lines in FIGS. 9B, 9C, and 9D, according to embodiments.

FIG. 11A depicts a schematic drawing of a classical imaging system without coincidence detection in a single-pass idler arm configuration, according to an embodiment.

FIG. 11B depicts a schematic drawing of a classical imaging system without coincidence detection in a triple-pass idler arm configuration, according to an embodiment.

FIG. 11C is a plot of lateral resolution versus z positions for the single-pass (solid line) and the triple-pass (dashed line) configurations shown in FIGS. 11A and 11B, according to an embodiment.

FIG. 12A depicts a classical image of a corner of a USAF target based on signal photons detected from the signal arm in FIG. 1, according to an embodiment.

FIG. 12B depicts a plot of contrast-to-noise ratios versus frame counts for CI images, according to an embodiment.

FIG. 12C depicts a plot of contrast-to-noise ratios versus frame counts for SR2 images and SR4 images, according to an embodiment.

FIG. 13A depicts a classical image of a USAF target at the object plane for ESF estimation, according to an embodiment.

FIG. 13B depicts a classical image based on photons from the single-pass idler arm in FIG. 11A with no object at object plane, according to an embodiment.

FIG. 13C depicts a classical image from the triple-pass idler arm in FIG. 11B with no object at object plane, according to an embodiment.

FIG. 14 depicts a schematic representation of the covariance technique, according to an embodiment.

FIG. 15A depicts CI images of the number 4 of USAF target before and after denoising, according to embodiments.

FIG. 15B depicts SR2 images of the number 4 of USAF target before and after denoising, according to embodiments.

FIG. 15C depicts SR4 images of the number 4 of USAF target before and after denoising, according to embodiments.

FIG. 16 depicts a flowchart of hyper-Heisenberg scaling quantum imaging method, according to embodiments.

FIG. 17 depicts components of a computing device, according to embodiments.

These and other features are described in more detail below with reference to the associated drawings.

### DETAILED DESCRIPTION

Different aspects are described below with reference to the accompanying drawings. The features illustrated in the drawings may not be to scale. In the following description, numerous specific details are set forth in order to provide a thorough understanding of the presented embodiments. The disclosed embodiments may be practiced without one or more of these specific details. In other instances, well-known operations have not been described in detail to avoid unnecessarily obscuring the disclosed embodiments. While the disclosed embodiments will be described in conjunction with the specific embodiments, it will be understood that it is not intended to limit the disclosed embodiments.

### I. INTRODUCTION TO HYPER-HEISENBERG SCALING QUANTUM IMAGING

The spatial resolution of an optical imaging setup has been typically limited by the Heisenberg scaling. The Heisenberg scaling posits that the maximum spatial resolution enhancement achievable using N entangled photons is N times. There has been significant interest in quantum metrology to attain the Heisenberg scaling through photon entanglement. While efforts to exceed the Heisenberg scaling have been made in non-imaging metrology, such endeavors have either depended on nonlinearity or the use of multiple object replicas. Surpassing the Heisenberg scaling in imaging has remained an unattained goal.

Techniques disclosed herein relate generally to quantum super-resolution imaging systems and methods that offer a spatial resolution improvement of up to four times that of traditional microscopes. More specifically, disclosed herein are hyper-Heisenberg scaling quantum (HHSQ) imaging techniques that surpass the Heisenberg scaling without depending on nonlinearity or the use of multiple object replicas. In various implementations, HHSQ imaging techniques use an entangled photon source such as a spontaneous parametric down-conversion (SPDC) source to generate entangled photon pairs for widefield illumination and a detector such as an electron multiplying charge-coupled device (EMCCD) camera for coincidence detection. Entangled photon pairs (e.g., where number of entangled parties, N_{EP},=2) are split into signal and idler arms, where the object being imaged is placed in the signal arm. The signal photons traverse the object in the signal arm at least once whereas the idler photons traverse the idler arm in multiple passes to surpass the hyper-Heisenberg scaling providing a spatial resolution improvement of more than two times (e.g., fourfold improvement for three-pass configuration) over classical imaging techniques.

In certain embodiments, hyper-Heisenberg scaling quantum (HHSQ) imaging techniques facilitate a seamless transition between three distinct imaging configurations: (i) a classical imaging (CI) configuration, (ii) a 2-fold super-resolution imaging (SR2) configuration, and (iii) a 4-fold super-resolution imaging (SR4) configuration. Compared with the SR2 configuration where a photon passes through the idler beam once, the SR4 configuration provides that the photon travels through the idler beam three times to surpass the Heisenberg scaling (hyper-Heisenberg scaling). Section III discusses experimental results that show that the SR2 and SR4 configurations provide twofold (i.e., Heisenberg scaling) and fourfold (i.e., hyper-Heisenberg scaling) resolution enhancements, respectively, over the CI configuration in both one-dimensional and two-dimensional imaging.

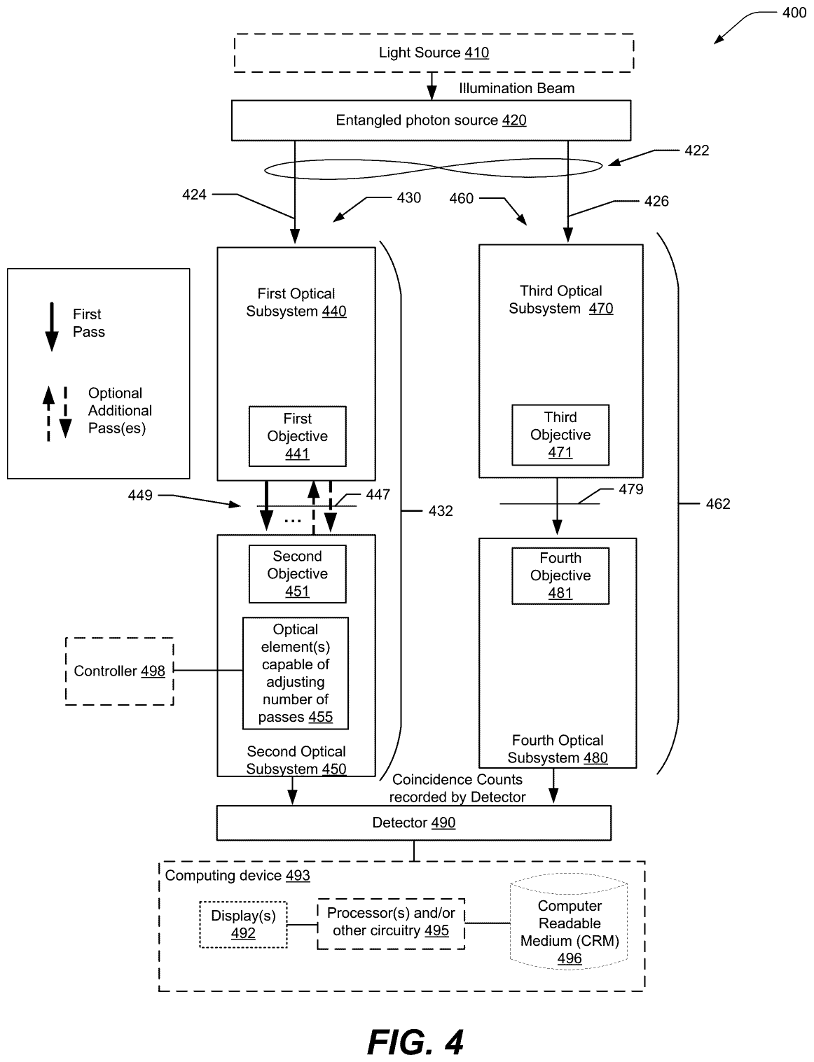

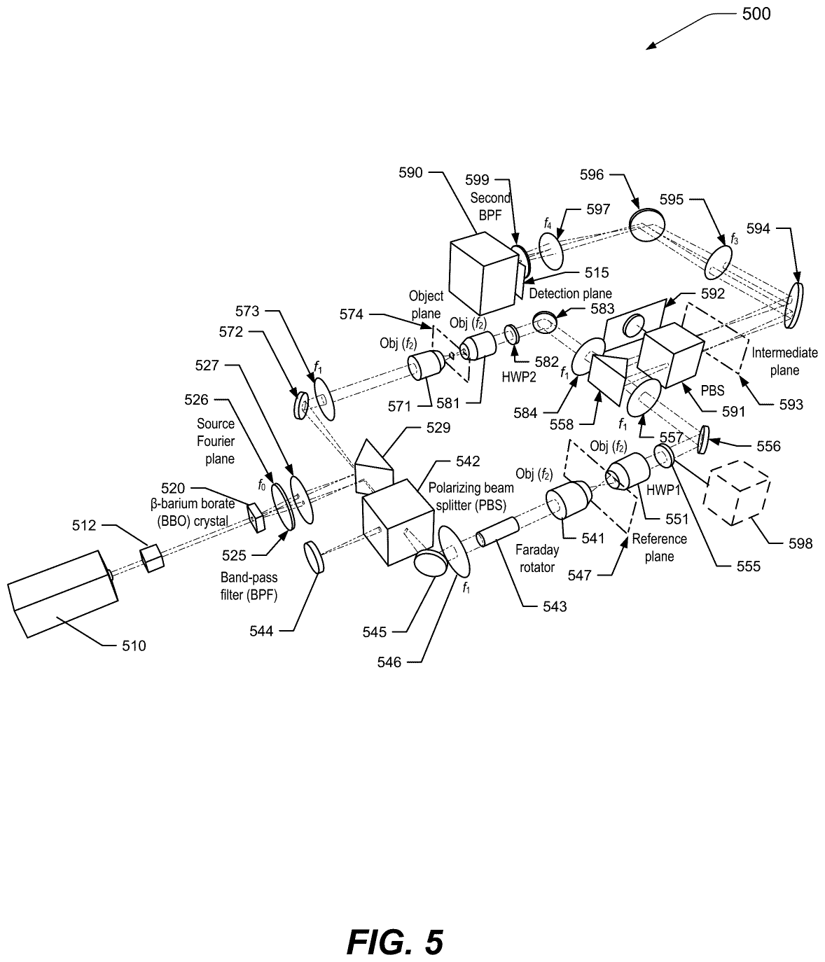

Certain hyper-Heisenberg scaling quantum imaging techniques described herein implement a widefield imaging setup with an entangled photon source (e.g., an SPDC source for widefield illumination and a detector (e.g., an EMCCD camera) for widefield detection. Some examples of hyper-Heisenberg scaling quantum imaging systems with widefield imaging setups are the hyper-Heisenberg scaling quantum imaging system 400 shown in FIG. 4 and the hyper-Heisenberg scaling quantum imaging system 500 shown in FIG. 5. In alternative implementations, these widefield systems are modified to be scanning-based. For example, these systems may be modified to include features for focusing an illumination beam from the light source (e.g., light source 410 in FIG. 4) onto the object being imaged by an objective lens and for raster scanning. For instance, point detection systems like the single-photon counting modules (SPCMs) and superconducting nanowire single-photon detectors (SNSPDs) could be integrated into the HHSQ systems, replacing the EMCCDs, and potentially offering performance on par with the hyper-Heisenberg scaling quantum imaging system 500 shown in FIG. 5.

Although an EMCCD camera is described as employed by certain hyper-Heisenberg scaling quantum imaging systems described herein, other detectors may be employed in alternate implementations of these systems. For example, a single-photon avalanche diode (SPAD) array camera or a scientific complementary metal-oxide-semiconductor (sCMOS) camera may be employed to replace the EMCCD and match or improve performance.

According to one aspect, a hyper-Heisenberg scaling quantum imaging system implements an entangled photon source (e.g., an SPDC source) for widefield illumination and a detector (e.g., an EMCCD camera) for coincidence detection, and has features for a triple-pass configuration in an idler arm for hyper-Heisenberg scaling (HHS) imaging in addition to features for a single-pass configuration in a signal arm for Heisenberg scaling (HS) imaging. The hyper-Heisenberg scaling quantum imaging system can also use the data from only the signal arm in classical imaging (CI) configuration to generate CI images. The features of hyper-Heisenberg scaling quantum imaging system can facilitate transition among the three distinct imaging configurations: a classical imaging (CI) configuration, a 2-fold super-resolution imaging (SR2) configuration, and a 4-fold super-resolution imaging (SR4) configuration, which achieve the classical resolution, HS resolution, and HHS resolution, respectively. For example, features may be used to switch between the different configurations. For instance, a half-wave plate (e.g., half-wave plate 555 in FIG. 5) in the idler arm may be set to different settings to switch between SR2 and SR4 imaging configurations. For example, in one implementation when the fast axis of the half-wave plate is set to 22.5° (π/8) the idler beam undergoes a single pass through the idler objective pair to form an SR2 image and when the fast axis of the half-wave plate is set to 67.5° (3π/8) the idler beam traverses the idler objective pair thrice to yield an SR4 image.

According to various implementations, the SR2 and SR4 configurations show twofold and fourfold resolution enhancements, respectively, over the CI resolution in the one-dimensional edge-spread functions as discussed in Section III. For example, in two-dimensional microscopic imaging of a resolution target, the SR4 configuration resolves better than the CI configuration and SR2 configuration. This resolution enhancement is discussed in Section III.

As discussed herein such as in Section III, the capabilities of hyper-Heisenberg scaling quantum imaging techniques in imaging microscopic features at enhanced spatial resolutions have been shown. This suggests the potential of hyper-Heisenberg scaling quantum imaging techniques in biological microscopy, providing a discernible advantage in unveiling more intricate details as compared to conventional microscopes.

Without resorting to either nonlinearity or multiple replicas of the object, certain quantum super-resolution imaging techniques disclosed herein surpass the Heisenberg scaling. Using entangled photon pairs (where N_{EP}=2) incident on a linear imaging system in SR2 and SR4 configurations, these quantum super-resolution imaging techniques can enhance the classical resolution by factors of two and four, respectively. The signal photons traverse the object in one arm at least once, whereas the idler photons traverse the other arm symmetrically either once or thrice. In some cases, the signal photons traverse the object in the one arm only once.

### A. Comparison to Systems that Use Nonlinear Transformation or Replication of the Object

Breaking the HS has been investigated theoretically using either nonlinear transformation (i.e., the Kerr effect) or replicating the object. Two experiments have been found to theoretically break the Heisenberg scaling HS but differ significantly from HHSQ imaging techniques. The first experiment is described in Napolitano, M. et al., “Interaction-based quantum metrology showing scaling beyond the Heisenberg scaling.” Nature 471, 486-489 (2011). The first experiment uses nonlinear light-matter interaction, whereas the SR4 configuration of HHSQ imaging techniques uses a linear imaging system. The second experiment is described in Yin, P. et al., “Experimental super-Heisenberg quantum metrology with indefinite gate order,” Nat. Phys. 1-6 (2023). The second experiment replicates the object 2N times in each arm of a Mach-Zehnder interferometer to perturb both conjugate observables (i.e., displacement and momentum) simultaneously but in opposite sequences, whereas the SR4 configuration of HHSQ imaging techniques employs a single instance of the object in one arm and may only transmit the signal photons once through the object in some cases.

### B. Classical Imaging and Quantum Super-Resolution Imaging Configurations

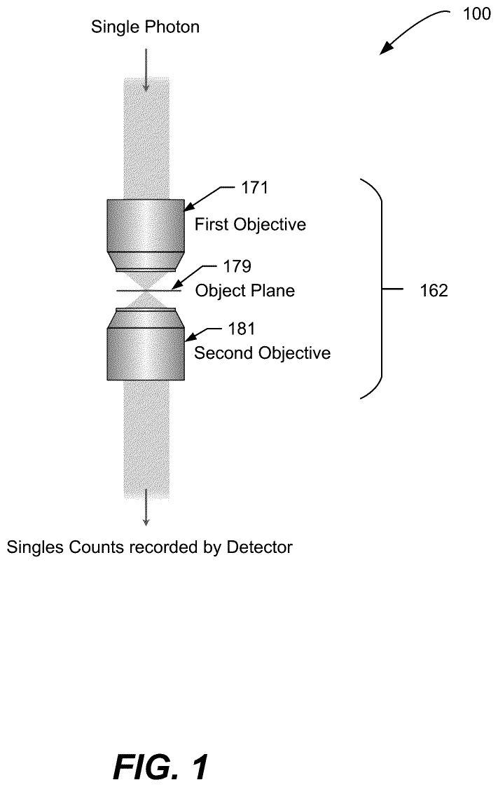

FIGS. 1-3 are schematic drawings illustrating the principles of three configurations: a classical imaging (CI) configuration, a 2-fold quantum super-resolution imaging (SR2) configuration, and a 4-fold quantum super-resolution imaging (SR4) configuration. One or more of these configurations can be implemented by certain hyper-Heisenberg scaling quantum imaging systems described herein. For example, a hyper-Heisenberg scaling quantum imaging system may have components that can switch between operational modes for CI imaging, for SR2 imaging, and/or for SR4 imaging.

FIG. 1 depicts a classical imaging (CI) configuration 100 that uses singles counts of photons, according to embodiments. CI configuration 100 includes an optical assembly 162 with a first objective 171 and a second objective 181. CI configuration 100 also includes an object plane 179 between the first objective 171 and the second objective 181. In classical imaging configuration 100, the singles counts of photons passing through an object at an object plane 179 can be recorded by a detector (e.g., a CCD sensor) to yield a CI image.

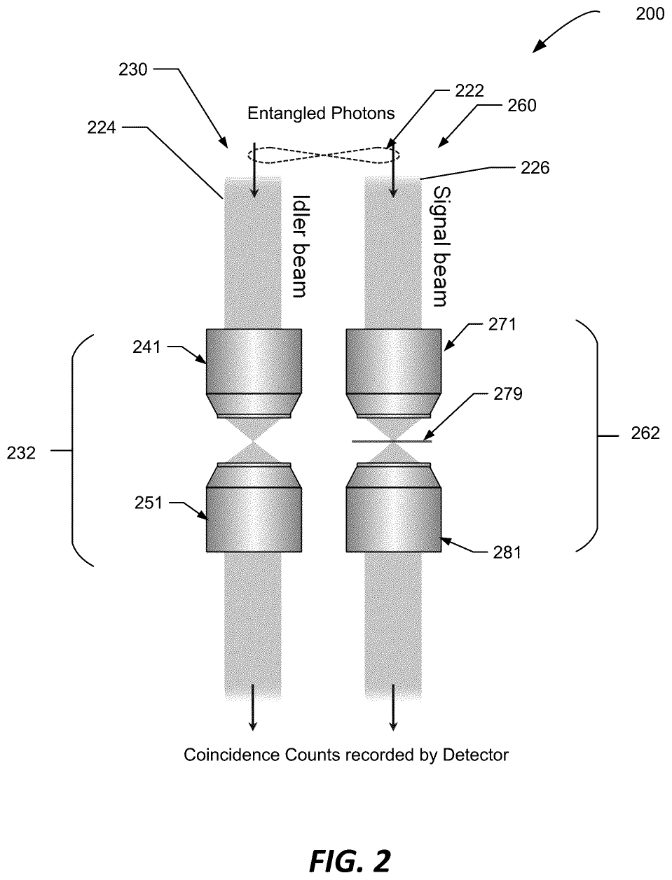

FIG. 2 depicts a 2-fold quantum super-resolution imaging (SR2) configuration 200 for resolving at the Heisenberg scaling through coincidence detection with a single-pass idler arm 230, according to embodiments. To attain the Heisenberg scaling, the SR2 configuration 200 uses entangled photon pairs. SR2 configuration 200 includes a single-pass idler arm optical assembly 232 with a first objective 241 and a second objective 251 and a signal arm optical assembly 262 with a third objective 271 and a fourth objective 281. The single-pass idler arm optical assembly 232 and signal arm optical assembly 262 have symmetric optical paths, i.e., all the optical components used in the setup and their separations are identical. An object plane 279 lies between the third and fourth objectives 271, 281. In the SR2 configuration 200, the signal photons traverse an object at the object plane 279 in the signal arm 260 one or more times (at least once) and the idler photons traverse the single-pass idler arm 230 symmetrically once. During operation, an entangled photon pair 222 is split into an idler beam 224 and a signal beam 226 using, for example, one or more beam-splitting elements (e.g., a prism such as, for example, right-angle prism mirror 529 in FIG. 5). For coincidence detection, the idler beam 224 is transmitted through the single-pass idler arm 230 and the signal beam 226 is transmitted through the signal arm 260, which transmits the signal photon through the object plane 279. A detector such as an EMCCD camera (e.g., EMCCD camera 590 in FIG. 5) may be used to record the coincidence counts to form an SR2 image with up to twice the spatial resolution of the CI image. Generally speaking, a pair of entangled photons traversing symmetric optical paths in two separate arms such as the idler and signals arms of various implementations behave like a single photon with half the original wavelength, which in this example results in a two-fold resolution improvement over classical imaging following the Heisenberg scaling.

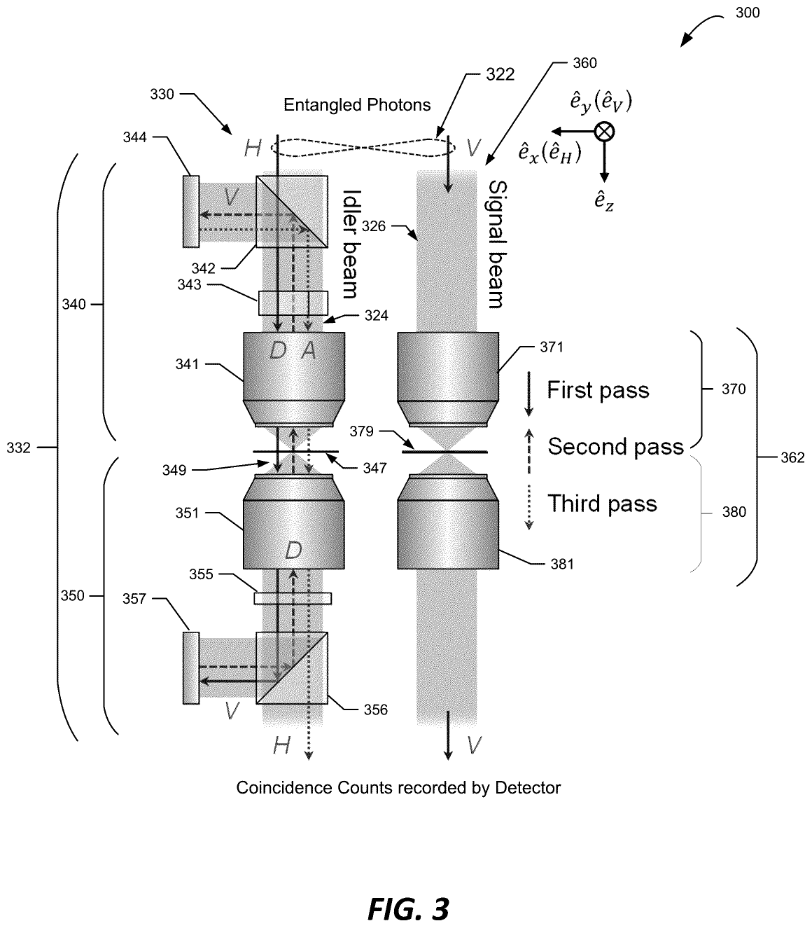

FIG. 3 depicts a 4-fold quantum super-resolution imaging (SR4) configuration 300 for resolving at a hyper-Heisenberg scaling through coincidence detection of entangled photon pairs with a triple-pass idler arm 330, according to embodiments. For the purposes of the illustration, the three light paths 349 of the three passes (triple passes) through the triple-pass idler arm 330 are shown separated. In actuality, the three light paths 349 are coincident. The SR4 configuration 300 includes a triple-pass idler arm optical assembly 331 including a first optical subsystem 340 and a second optical subsystem 350. The first optical subsystem 340 includes a first polarizing beam splitter (PBS) 342, a Faraday rotator (FR) 343 for rotating the polarization state non-reciprocally, a first mirror 344 and a first objective 341. The second optical subsystem 350 includes a second objective 351, a half wave plate (HWP) 355 for rotating polarization based on a fast axis setting, a second polarizing beam splitter (PBS) 356 for passing light in a horizontal polarization state, and a second mirror 357. The SR4 configuration 300 also includes a signal arm optical assembly 362 with a third optical subsystem 370 having a third objective 371 and a fourth optical subsystem 380 having a fourth objective 381. The triple-pass idler arm optical assembly 332 and signal arm optical assembly 362 have symmetric optical paths. An object plane 379 lies between the third and fourth objectives 371, 381 and a reference plane 347 lies between the first and second objectives 341, 351. In this SR4 configuration 300, the signal photons traverse an object at the object plane 379 in the signal arm 360 one or more times (at least once) and the idler photons traverse the triple-pass idler arm 330 symmetrically thrice. In the illustration, horizontal polarization is designated by a “H,” vertical polarization is designated by a “V,” diagonal polarization is designated by a “D,” and anti-diagonal polarization is designated by an “A.” During operation, an entangled photon pair 322 is split into an idler beam 324 and a signal beam 326 using one or more beam-splitting clements. For example, a prism such as the right-angle prism mirror 529 in FIG. 5 may be used. For coincidence detection, the idler beam 324 is transmitted through the triple-pass idler arm 330 and the signal beam 326 is transmitted through the signal arm 360, which transmits the signal photon through the object plane 379. A detector such as an EMCCD camera may be used to record the coincidence counts to form an SR4 image with up to four times the spatial resolution of the CI image. The pair of entangled photons traversing the symmetric optical paths in two separate arms behave like a single photon with a quarter the original wavelength, which results in the four-fold resolution improvement over classical imaging following the hyper-Heisenberg scaling (HHS). By directing idler photons through the idler objective pair 341, 351 in the triple-pass idler arm 330 thrice and correlating them with the signal photons passing through the signal objective pair 371, 381, the spatial resolution using this linear imaging system can be enhanced by four times over the classical spatial resolution reaching the hyper-Heisenberg scaling.

In various embodiments described herein, hyper-Heisenberg scaling quantum imaging systems can surpass the HS limit by implementing an idler arm optical assembly that provides repeated trips (e.g., number of passes (P)=3, 4, 5, 6, 7, 8, . . . ) through the idler arm. For example, a hyper-Heisenberg scaling quantum imaging system can include a triple-pass idler arm optical assembly where the idler photons traverse the triple-pass idler arm symmetrically in three passes. Some examples of quantum super-resolution imaging systems with triple-pass idler arm optical assemblies, triple-pass idler arm optical assembly 332 and triple-pass idler arm assembly 532, are shown in FIG. 3 and FIG. 5 respectively.

The enhanced resolution, r_{SR}, of a quantum super-resolution imaging system configured for one or more passes through the idler arm is given by:

$${r}_{SR} ( P ) = \frac{{r}_{CI}}{\frac{P + 1}{2} + {N}_{EP}} , \qquad ( Eqn . 1 )$$

where r_{CI} is the CI image resolution, P is the number of passes, and N_{EP} is the number of entangled photons.

In examples where N_{EP}=2 such as in the illustrated examples shown in FIG. 2, FIG. 3, FIG. 4, and FIG. 5, the enhanced resolution r_{SR} is given by:

$${r}_{SR} ( P ) = \frac{{r}_{CI}}{P + 1} , \qquad ( Eqn . 2 )$$

The SR2 configuration 200 shown in FIG. 2 includes a single-pass idler arm optical assembly 232 with a single pass (P=1) and according to Eqn. 2 yields an enhanced resolution, r_{SR}, of r_{CI}/2, which is an estimated two-fold enhancement in spatial resolution over classical (CI) imaging. The SR4 configuration 300 shown in FIG. 3 includes a triple-pass idler arm optical assembly 332 with triple passes (P=3) according to Eqn. 2 yields an enhanced resolution, r_{SR}, of r_{CI}/4, which is an estimated four-fold enhancement in spatial resolution over classical imaging.

### II. HYPER-HEISENBERG SCALING QUANTUM IMAGING SYSTEMS

In various embodiments, quantum super-resolution imaging systems including hyper-Heisenberg scaling quantum imaging systems have an idler arm and a signal arm with balanced optical pathlengths and magnification ratios. Having balanced optical magnification ratios means that the magnification of the optical elements in the idler arm and signal arm optical assemblies are the same. The balanced optical pathlengths require symmetry in the optical paths of the signal and idler photons from the source Fourier plane (Fourier plane of entangled photon source) to the detection planes, such that the paired photons are correlated in positions and momentums concurrently, and the phases of the paired photons can be combined. This requirement cannot be satisfied through classical unentangled sources because two unentangled photons can only be correlated in either position or momentum in accordance with the uncertainty principle. As a consequence to maintaining optical path symmetry in a quantum super-resolution imaging systems, all entangled photon pairs should appear at positions symmetric about the same center within the source Fourier plane, the object plane, and the detection plane. To maintain path symmetry as precisely as possible, the optical arrangement of the signal arm (signal arm optical assembly) is mirrored in the optical arrangement of the idler arm (idler arm optical assembly) according to various embodiments. The photon pairs on the symmetric positions on the source Fourier plane propagate symmetrically due to the phase matching, and propagate through the identical pairs of optical arrangements to reach the object plane and the reference plane, respectively. Though scattering by the object may appear to disrupt the path symmetry, pathlength symmetry is maintained because the conjugation between the object and detection planes balances the optical pathlengths of a scattered signal photon and the related idler photon. Therefore, configurations with balanced pathlengths can be used to describe the biphoton propagation from the source Fourier plane to the detection plane. Quantum super-resolution imaging systems with idler arms having multiple passes are capable of surpassing the Heisenberg scaling and are generally referred to herein as “hyper-Heisenberg scaling quantum imaging systems.”

As used herein, an “SR2 configuration” or “single-pass configuration” refers to an optical imaging setup with coincidence detection of idler and signal photons where there is a single pass (P=1) of the idler photons through a reference plane in the idler arm. As used herein, an “SR4 configuration” or “triple-pass configuration” refers to an optical imaging setup with coincidence detection of idler and signal photons where there are three passes (P=3) of the idler photons through the reference plane in the idler arm. The reference plane generally has a symmetric position to an object plane in the signal arm. Generally speaking, SR2 (single-pass) and SR4 (triple-pass) configurations are lincar imaging systems with optical symmetry between the idler and signal arms. Some examples of SR4 configurations are provided in FIG. 3, FIG. 4, and FIG. 5. An example of an SR2 configuration is provided in FIG. 2. As used herein a “C1 configuration” refers to a classical imaging setup without coincidence detection. An example of a CI configuration is provided in FIG. 1.

FIG. 4 is a block diagram of components of a hyper-Heisenberg scaling quantum (HHSQ) imaging system 400, according to various embodiments. In this example, the HHSQ imaging system 400 includes a controller 498 that can control the operational configuration (also referred to as an “imaging mode”) being implemented to form one or more images. For example, the controller 498 can send control signals to switch between a classical imaging (CI) configuration to form a CI image (CI imaging mode), a 2-fold quantum super-resolution imaging (SR2) configuration to form an SR2 image (SR2 imaging mode), and a 4-fold quantum super-resolution imaging (SR2) configuration to form an SR4 image (SR4 imaging mode). In another implementation, the controller 498 can send control signals to switch to two or more of the three modes: CI imaging mode, SR2 imaging mode, and SR4 imaging mode. In yet another implementation, the controller 498 may be omitted and HHSQ imaging system 400 may only implement the SR2 configuration or the SR4 configuration for SR2 and SR4 imaging modes, respectively.

In FIG. 4, HHSQ imaging system 400 is shown during operation in an imaging configuration that includes one or more passes (e.g., 1, 3, 5, 7, 9, etc.) of idler photons through a reference plane 447 at the first and second objectives 441, 451 (idler objective pair) and passing signal photons through the object plane 479 at the third and fourth objectives 471, 481 (signal objective pair). The one or more passes of the idler photons through the idler objective pair include a first pass and one or more optional additional passes. For example, in one aspect, the idler photons pass once through the idler objective pair. In another aspect, the idler photons pass three times through the idler objective pair. In yet other aspects, the idler photons may pass more than three times through the idler objective pair. The first and second objectives 441, 451 are identical or substantially identical to the third and fourth objectives 471, 481. For the purposes of the illustration, light paths 449 of the one or more passes through the first and second objectives 441, 451 are shown separated. In actuality, the light paths 449 are coincident.

HHSQ imaging system 400 includes an optional (denoted by dashed line) light source 410 (e.g., a continuous-wave laser) that provides an illumination beam. HHSQ imaging system 400 also includes an entangled photon source 420 (e.g., a spontaneous parametric down-conversion (SPDC) source such as a β-barium borate (BBO) crystal or a periodically poled potassium titanyl phosphate (PPKTP) crystal) in optical communication with the light source 410. During operation, the entangled photon source 420 receives the illumination beam from the light source 410 and generates entangled photon pairs (N_{EP}=2) 422. In the illustrated example, light source 410 is providing an illumination beam in a widefield imaging setup. In an alternative scanning-based implementation, HHSQ imaging system 400 may include a focusing lens to focus the illumination beam from the light source 410 and a raster scanning component may be implemented for raster scanning the focused illumination beam across the field-of view. In some cases, the light source 410 may be part of the HHSQ imaging system 400. In other cases, the light source 410 may be a separate component.

During operation of the implementation of HHSQ imaging system 400 shown in FIG. 4, each entangled photon pair 422 is split into an idler beam 424 and a signal beam 426. In some cases, one or more beam-splitting clements (e.g. a prism such as right-angle prism mirror 529 in FIG. 5) may be employed to split each entangled photon pair 422 into an idler beam 424 and a signal beam 426. HHSQ imaging system 400 also includes an idler arm optical assembly 432 and a signal arm optical assembly 462. The idler arm optical assembly 432 and signal arm optical assembly 462 have symmetric optical paths. The idler arm optical assembly 432 includes a first optical subsystem 440 having a first objective 441 and a second optical subsystem 450 having a second objective 451 and one or more optical elements 455 (e.g., half-wave plate or a Kerr gate) capable of adjusting the number of passes through the reference plane 447. The signal arm optical assembly 462 includes a third optical subsystem 470 having a third objective 471 and a fourth optical subsystem 481 having a fourth objective 481. An object plane 479 lies between the third and fourth objectives 471, 481 of the signal arm 460.

HHSQ imaging system 400 also includes a detector 490 (e.g., an EMCCD camera) that can be employed to record coincident counts from idler photons from the idler arm optical assembly 432 and signal photons from the signal arm optical assembly 462 for coincidence detection for, for example, SR2 or SR4 imaging. By employing such a mode of operation for coincidence detection of idler photons directed in one or more passes through the idler objective pair 441, 451 in the idler arm 430 and signal photons through the object plane 479 between the signal objective pair 471, 481 in the signal arm 460, and then correlating the idler photons with the signal photons, the spatial resolution using the linear imaging system can be enhanced over classical imaging according to Eqn. 2 where P is the number of passes implemented. That is, if a single pass (P=1) through the idler objective pair 441, 451 of idler arm 430 is implemented, the enhanced resolution is twofold over classical imaging and if a triple pass (P=3) through the idler objective pair 441, 451 in the idler arm 430 is implemented, the enhanced resolution is fourfold over classical imaging in accordance with Eqn. 2. Photons from the signal arm alone may be recorded by detector 490 and used for classical imaging in a CI configuration.

According to one aspect, HHSQ imaging system 400 may be considered designed for versatility, allowing for transitions among the three imaging configurations: CI imaging, SR2 imaging, and SR4 imaging. The signal arm 460 in itself serves as a wide-field microscope, that can produce CI images. HHSQ imaging system 400 includes an optional controller 498 (e.g., a motorized controller) and one or more optical elements 455 in electrical communication with the optional controller 498 to be able to receive control signals to adjust the number of passes through the reference plane 447 and switch between imaging configurations. For example, the one or more optical elements may include a half-wave plate and the controller 498 may send control signals to the half-wave plate (e.g., half-wave plate 551 n FIG. 5) to change the fast axis of the half-wave plate to switch between SR2 imaging configuration and SR4 imaging configuration. For example, the fast axis of HWP may be set to 22.5° such that the idler beam undergoes a single pass through the idler objective pair, first and second objectives 441, 451. Under this setting, the detected coincidences can be used to form an SR2 image. As another example, the fast axis of the HWP may be set to 67.5° such that the idler beam traverses the objective pair thrice. In this case, the detected coincidences can be used to yield an SR4 image.

During operation, the idler beam 424 is transmitted through the idler arm 430 to transmit the idler photons in one or more passes along optical paths through the first and second objectives 441, 451. For example, when operating in SR2 configuration, the signal photons traverse an object at the object plane 479 in the signal arm 460 at least once and the idler photons traverse the idler arm 430 symmetrically once. In another example, when operating in SR4 configuration, the signal photons traverse an object at the object plane 479 in the signal arm 460 at least once and the idler photons traverse the idler arm 430 symmetrically thrice. In one implementation, the idler photons may be transmitted in a plurality of passes (e.g., 3, 5, 7, etc.) through the first and second objectives 441, 451 and the signal beam 426 transmitted through the signal arm 460, which transmits the signal photons through the object plane 479.

HHSQ imaging system 400 also includes an optional computing device 493 with one or more processors and/or other circuitry 495, a display 492 in electrical communication with the processor(s) or other circuitry 495, and a computer readable media (CRM) 496 (e.g., a non-transitory computer readable media) in electronic communication with the processor(s) or other circuitry 495. Computing device is in electronic communication with the detector 490 to receive image data. Processor(s) and/or other circuitry 495 are in electrical communication with CRM 496 to store and/or retrieve data. The one or more processor(s) and/or other circuitry 495 are in electrical communication with display 492 for, e.g., displaying images. Although not shown, computing device 493 may also include a user input device for receiving data such as system settings from an operator of HHSQ imaging system 400. The computing device 493 may be, for example, a personal computer, an embedded computer, a single board computer (e.g., Raspberry Pi or similar), a portable computation device (e.g., tablet), or any other computation device or system of devices capable of performing the functions described herein. Optionally, computing device 493 may be in communication with controller 498 to send control signals with control and synchronization data. In one aspect, the computing device 493 and controller 498 may be combined in a single apparatus.

The one or more processors and/or other circuitry 495 may execute instructions stored on the CRM 496 to perform one or more operations of an HHSQ imaging method. For example, processor(s) and/or other circuitry 495 may execute instructions for: 1) communicating control signals to one or more components of HHSQ imaging system 400, 2) register signal and idler images, 3) calculating pixel-to-pixel covariances, 4) reconstructing coincidence images from measurements taken by the detector, and/or 5) denoising image(s). The computer readable media (CRM) 496 may be, e.g., a non-transitory computer readable media.

The electrical communication between components of an HHSQ imaging system 400 may be in wired and/or wireless form. One or more of the electrical communications between components of an HHSQ imaging system 400 may be able to provide power in addition to communication signals. In some implementations, HHSQ imaging system 400 includes one or more communication interfaces (e.g., a universal serial bus (USB) interface). Communication interfaces can be used, for example, to connect various peripherals and input/output (I/O) devices such as a wired keyboard or mouse or to connect a dongle for use in wirelessly connecting various wireless-enabled peripherals. Such additional interfaces also can include serial interfaces such as, for example, an interface to connect to a ribbon cable. It should also be appreciated that the various system components can be electrically coupled to communicate with various components over one or more of a variety of suitable interfaces and cables such as, for example, USB interfaces and cables, ribbon cables, Ethernet cables, among other suitable interfaces and cables.

In various embodiments, an HHSQ imaging system includes a light source for introducing light to the detection plane. An example of a suitable light source is a continuous-wave laser. A suitable commercially-available continuous-wave laser source is the LM-405-PLR-40-4K 405 continuous-wave laser source sold by Coherent with an output power of 40 mW. Another suitable commercially-available continuous-wave laser source is the FQCW266-10-C laser source sold by Crystal Laser Systems GmbH (CryLaS) with an output power of 10 mW. Another suitable commercially-available continuous-wave laser source is the MLL-III-532 laser sold by CNI.

In various embodiments, an HHSQ imaging system includes an entangled photon source for generating entangled photon pairs. For instance, an entangled photon source may generate an entangled photon pair (N_{EP}=2) and one or more beam-splitting elements (e.g., a prism) can be used to separate the photon pair into an idler beam transmitted through an idler arm and a signal beam transmitted through a signal arm. An example of an entangled photon source is a spontaneous parametric down-conversion (SPDC) source that can generate entangled photon pairs utilizing the SPDC effect. Examples of SPDC sources include nonlinear crystals such as a B-barium borate (BBO) crystal and a periodically poled potassium titanyl phosphate (PPKTP) crystal. An example of a suitable commercially-available BBO crystal is the PABBO5050-266(I)-HA3 BBO crystal sold by Newlight Photonics. In some instances, a BBO crystal may be cut to customize for use with a particular light source. For example, in one instance, a BBO crystal is cut for use with a 266 nm wavelength continuous-wave laser source (e.g., FQCW266-10-C laser source sold by Crystal Laser Systems GmbH (CryLaS)) with an output power of 10 mW. Various sizes of non-linear crystals may be used. For example, a BBO crystal having dimensions of 5×5×0.5 mm³ may be used.

In various embodiments, an HHSQ imaging system includes one or more beam-splitting elements (e.g., prism, beam-splitter, etc.) that are configured to split entangled photon pairs generated by the entangled photon source into an idler beam and a signal beam. For example, the one or beam-splitting elements may include a prism such as a right-angle prism (e.g., right-angle prism mirror 529 in FIG. 5).

In various embodiments, an HHSQ imaging system includes a detector (sometimes referred to herein as a “camera” or “imaging sensor”) for coincidence detection that includes recording biphoton coincidence counts from both the idler arm and signal arm. According to one aspect, the detector includes a plurality of detector elements. In some cases, the detector elements may be in the form of a two-dimensional array, one or more one-dimensional arrays, or a combination thereof. According to another aspect, the detector may be a single detector. For example, a single detector may be scanned to an array of positions. The detector can take a plurality of coincidence measurements based on the arrival times of entangled photon pairs. An example of a suitable detector is an electron multiplying charge-coupled device (EMCCD). An electron multiplying charge-coupled device (EMCCD), which is also sometimes referred to herein as an “electron multiplying charge-coupled camera,” refers to a digital imaging sensor chip that includes an extended serial register on a charge-coupled device (CCD) chip that produces multiplication gain through the process of impact ionization in silicon. An EMCCD includes an array of charge-coupled device (CCD) sensors. The electron multiplying CCD sensors can amplify a captured signal before the charge is transferred to an on-chip amplifier, which has the effect of reducing the read noise, relative to the signal, by the value of the multiplication gain factor. The array of CCD sensors may be two-dimensional, one-dimensional, or a combination thereof. Any suitable number of CCD sensors may be implemented such as 512×512 and 1024×1024. An example of a suitable commercially-available EMCCD camera is the iXon Ultra 888 EMCCD camera sold by Andor. Another example of a suitable detector is a single-photon avalanche diode (SPAD) array. Another example of a suitable detector is a scientific complementary metal-oxide-semiconductor (sCMOS) camera. Other examples of suitable detectors include superconducting nanowire single photon detector (SNSPD) cameras.

In various embodiments, an HHSQ imaging system includes one or more optical clements configured to adjust the number of passes through the reference plane of the idler arm. In some embodiments, the one or more optical elements includes a half-wave plate for adjusting the polarization angle. An example of a suitable commercially available half-wave plate is the WPA03-H-405 half-wave plate sold by Newlight Photonics. In some cases, a half-wave plate (e.g., half-wave plate 555 in FIG. 5) in the idler arm may be set to different settings to switch between imaging configurations such as between SR2 imaging configuration and SR4 imaging configuration. For example, when the fast axis of the half-wave plate is set to 22.5° the idler beam undergoes a single pass through the objective pair, first objective to form an SR2 image. As another example, when the fast axis of the half-wave plate is set to 67.5°, the idler beam traverses the objective pair thrice to yield an SR4 image. In other cases, the half-wave plate may have a single fast axis setting. Although various examples of HHSQ imaging systems described herein employ include a half-wave plate and use setting of the half-wave plate to adjust the number of passes through the reference plane, in other implementations one or more other optical clements may be included and employed to adjust the number of passes. For example, Kerr gates may be employed in another implementation.

In various embodiments, an HHSQ imaging system includes a computing device (e.g., computing device 493 in FIG. 4) with one or more processors and/or other circuitry, an optional display in electrical communication with the processor(s), and a computer readable media (CRM) (e.g., a non-transitory computer readable media) in electronic communication with the processor(s) or other circuitry. Although not shown in FIG. 5, HHSQ imaging system 500 may include a computing device in an alternative implementation.

FIG. 5 is a schematic drawing of components of an HHSQ imaging system 500, according to embodiments. HHSQ imaging system 500 includes a spontaneous parametric down-conversion (SPDC) source in the form of a β-barium borate (BBO) crystal 520. The BBO crystal 520 can generate photon pairs, which are simultaneously correlated in position, momentum, polarization, and energy through the type-II SPDC process. According to one aspect, the BBO crystal 520 may be cut for type-II SPDC and have dimensions of 5×5×2.0 mm³. An example of a suitable commercially-available BBO crystal is the NCBBO5200-405 (II)-BL BBO crystal sold by Newlight Photonics.

HHSQ imaging system 500 also includes a light source 510 in the form of a pump laser. For example, the pump laser may be a 405 nm continuous-wave laser with an output power of 40 mW such as the LM-405-PLR-40-4K laser sold by Coherent. HHSQ imaging system 500 also includes a laser polarizer 512 (e.g., a Glan-Laser polarizer such as the GLB10-A Glan-Laser polarizer sold by Thorlabs) and a half-wave plate 555 (e.g., the WPA03-H-405 half-wave plate sold by Newlight Photonics) that are used to adjust the polarization angle of the pump laser beam to be horizontally polarized. The pump laser beam then passes through the BBO crystal 520 and generates SPDC photons. HHSQ imaging system 500 also includes a band-pass filter (BPF) 525 that is used to block the pump beam. For example, the BPF 525 may be a band-pass filter with a center wavelength of 810 nm and a bandwidth of 30 nm such as the NBF810-30 band-pass filter sold by Newlight Photonics. HHSQ imaging system 500 also includes a f₀=50 mm lens 527 and a right-angle prism mirror 529 (e.g., the MRAK25-P01 knife-edge prism mirror sold by Thorlabs). The generated SPDC photon pairs propagate through the f₀=50 mm (first) lens 527 to the Fourier plane, i.e., the source Fourier plane (P₀) 526, and are spatially separated using the right-angle prism mirror 529. The signal and idler photons are split into two arms by right-angle prism mirror 529. The optical paths of the signal arm and the first pass within the idler arm are built symmetrically to ensure balanced optical paths and magnification ratios, for super resolution at the HS and HHS in SR2 and SR2 imaging, respectively.

HHSQ imaging system 500 includes an idler arm optical assembly including a first polarizing beam splitter (e.g., PBS252 beam splitter sold by Thorlabs) 542, a first mirror 544, a second mirror 545, a second lens 546, a Faraday rotator (e.g., I780R5 Faraday rotator sold by Thorlabs), a first objective 541, a second objective 551, the half-wave plate 555, a third mirror 556, and a third lens 557. HHSQ imaging system 500 also includes a signal arm optical assembly including a third mirror 572, fourth lens 573, a third objective 571, a fourth objective 581, a second HWP 582, a fourth mirror 583, and a fifth lens 584. HHSQ imaging system 500 also includes another (second) right-angle prism mirror 558, a second PBS 591, a fifth mirror 592, an intermediate plane 593, a sixth mirror 594, a sixth lens 595, a seventh mirror 596, a seventh lens 597, a second band-pass filter 597, and an EMCCD camera 590. A reference plane 547 lies between the first and second objectives 541 and 551. An object plane 574 lies between the third and fourth objectives 571 and 581. The EMCCD camera 590 includes a detection plane 515.

The two polarizing beam splitters 542, 591, second mirror 545 and third mirror 556, and the Faraday rotator 543 are utilized for the triple-pass configuration (also referred to herein as the “SR4” configuration). The separated signal and idler photons propagate to the object plane (P_{obj}) 574 and the reference plane (P_{ref}) 547, respectively, by two identical 4f imaging systems comprising of an f₁=180 mm lens and an f₂=9 mm objective (e.g., LI-20X objective sold by Newport). The sample is placed at the object plane 574 during operation. The object plane 574 or reference plane 547 and the intermediate plane 593 are conjugated through the other two identical 4f imaging systems, which consists of an identical set of f₂=9 mm objectives (541, 551 and 571, 581) and f₁=180 mm lenses and another right-angle prism mirror 558. Each of the second objective 551 and fourth objective 581 is followed by the same half-wave plate, 555, 582 (e.g., WPA03-H-810 half-wave plate sold by Newlight Photonics). By rotating the first HWP 555 about the optical axis in the idler arm, HHSQ imaging system 500 can switch between the SR2 configuration and the SR4 configuration. The intermediate plane 593 and the detection planc (P_{det}) 515 of an EMCCD camera 590 (e.g., iXon Ultra 888 EMCCD camera sold by Andor) are conjugated through a 4f system consisting of f₃=300 mm and f₄=200 mm lenses. Another BPF 599 (e.g., NBF810-30 band-pass filter sold by Newlight Photonics) is placed in front of the EMCCD camera 590 to block unwanted stray light. In one example, the EMCCD camera 590 may be operated at −65° C., with a horizontal pixel shift readout rate of 10 MHz, a vertical pixel shift speed of 1.13 μs, and an electron multiplier (EM) gain of 1000. The components of HHSQ imaging system 500 may be covered by a light-shielding box.

During operation, the BBO crystal 520 is used to generate photon pairs, which are simultaneously correlated in position, momentum, polarization, and energy through the type-II SPDC process. The signal and idler photons are split into two arms by the first right-angle prism mirror 529. The optical paths of the signal arm and the first pass within the idler arm are built symmetrically to ensure balanced optical paths and magnification ratios, for super resolution at the HS and HHS. The photon pairs are coincidence counts between the two arms are detected by an EMCCD camera 590, and a covariance-based algorithm described in Methods Section IV is used to determine coincidence intensities.

HHSQ imaging system 500 is designed for versatility, allowing for transitions among the three imaging configurations: CI imaging, SR2 imaging, and SR4 imaging. The signal arm in itself serves as a wide-field microscope, producing CI images. When the fast axis of HWP 555 is set to 22.5°, the idler beam undergoes a single pass through the objective pair 541, 551. Under this setting, the coincidences form an SR2 image. When the fast axis of HWP 555 is set to 67.5°, the idler beam traverses the objective pair thrice. In this case, the coincidences yield an SR4 image.

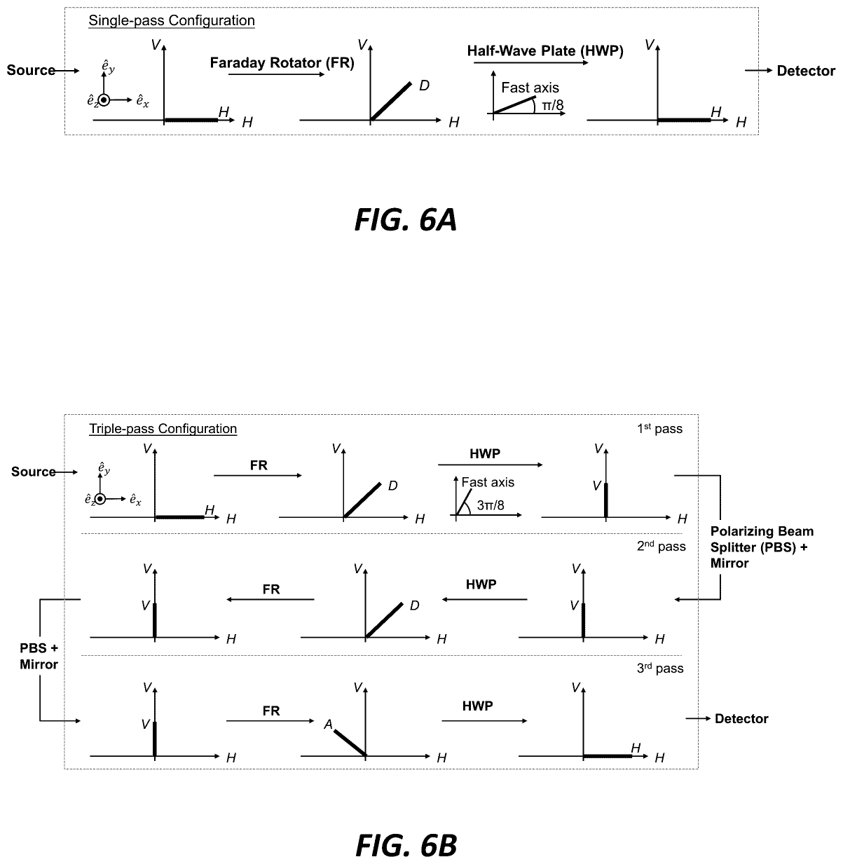

FIG. 6A depicts plots of examples of polarization-state transformations in the idler arm of a HHSQ imaging system (e.g., idler arm 430 of HHSQ imaging system 400 in FIG. 4 or idler arm of HHSQ imaging system 500 in FIG. 5) for a single-pass configuration, according to embodiments. FIG. 6B depicts plots of examples of polarization-state transformations in the idler arm of a HHSQ imaging system for a triple-pass configuration, according to embodiments. For single pass, the fast axis is set to π/8 (22.5 degrees). For triple pass, the fast axis is set to 3π/8 (67.5 degrees).

### III. EXPERIMENTAL DATA

### A. Edge-Spread Quantification of Spatial Resolution

The spatial resolutions of the CI, SR2, and SR4 configurations of the HHSQ imaging system 500 in FIG. 5 were quantified using an edge of a US Air Force (USAF) 1951 resolution target. The edge spread functions (ESFs) were acquired at z positions varied with a step size of 10 μm. Subsequently, line spread functions (LSFs) were calculated, and their full widths at half maximum (FWHMs) were utilized to estimate the spatial resolutions.

To quantify the spatial resolution of the HHSQ imaging system 500 in FIG. 5, the intensities were extracted along a line perpendicular to an edge in the USAF resolution target and the intensities were fit to an ESF using an error function centered at x₀, i.e., ESF(x)=a erf[x−x₀)/w]+b, where a and b are coefficients and w is the waist radius of the beam. A Gaussian LSF is obtained by taking the derivative of the ESF, i.e., LSF(x)=dESF(x)/dx=2a exp[−(x−x₀)²/w²]/(w\sqrt{π}). The resolution is estimated by the FWHM of the LSF, i.e., [symbol] =2\sqrt{ln2}w.

To estimate the standard errors from the fitted ESFs, the 95% confidence interval of the fitted parameter w (denoted as [w_{sub}, wₛᵤₚ]) was acquired. From the confidence interval, the standard errors of w are estimated as se_{w}=(wₛᵤₚ−w_{sub})/3.92 according to the z test. From [symbol] =2\sqrt{ln2}w, the standard errors of the FWHM of the LSFs are estimated as se [symbol] =\sqrt{ln 2}(wₛᵤₚ−w_{sub})/1.96 .

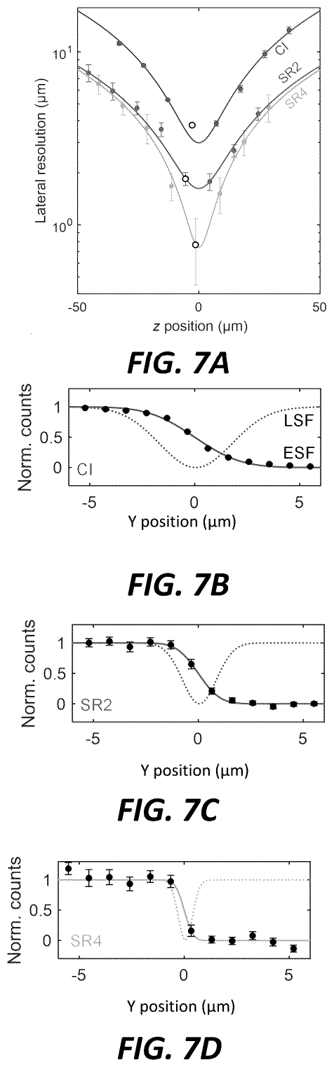

FIG. 7A is a plot of the lateral spatial resolutions along y versus z (optical axis) for the CI, SR2, and SR4 configurations of the HHSQ imaging system 500 in FIG. 5, according to an implementation. The dots represent the experimental data, each plotted as the mean±standard error of the mean (n=30), and solid lines denote fits. The three curves are shifted to align the fitted foci to z=0. The curves were fitted in accordance with the Gaussian beam width and shifted slightly (much less than the step size) to align the foci. The minima of the fitted CI, SR2, and SR4 resolution curves, representing the focal spatial resolutions, are 2.98±0.42 μm, 1.62±0.28 μm, and 0.74±0.22 μm, respectively.

Compared with the SR2 configuration, which is at the HS, the SR4 configuration further enhances the resolution to achieve the HHS, confirmed by a p-value of 0.0097 from a two-sample t-test. Relative to CI, SR2 and SR4 configurations enhance the resolution by factors of 1.84±0.41 μm and 4.03±1.32 μm, respectively. These resolution enhancements align with Eqn. 1 for P=1 (single pass) and P=3 (triple passes). Also, the depths of field along z, defined as the full width of each fitted curve at \sqrt{2} of the minimum, are 17.54±1.40 μm, 19.98±2.01 μm, 9.41±1.48 μm for CI, SR2, and SR4 configurations, correspondingly.

FIGS. 7B-7D depict the experimental measurements at the same physical position near the focus along with the fitted ESFs and LSFs. From the FWHMs of the LSFs, the spatial resolutions of CI, SR2, and SR4 configurations are 3.78±0.07 μm, 1.85±0.16 μm, 0.77±0.32 μm, respectively. FIG. 7B is a plot of the edge spread function (ESR) and line spread function (LSF) of CI images yielded by the HHSQ imaging system 500 in FIG. 5 measured near the foci marked by the corresponding black circle with white centers in FIG. 7A, according to an implementation. FIG. 7C is a plot of the edge spread function (ESR) and line spread function (LSF) of SR2 images yielded by the HHSQ imaging system 500 in FIG. 5 measured near the foci marked by the corresponding black circle with white centers in FIG. 7A, according to an implementation. FIG. 7D is a plot of the ESR and LSF of SR4 images yielded by the HHSQ imaging system 500 in FIG. 5 measured near the foci marked by the corresponding black circle with white centers in FIG. 7A, according to an implementation. The ESFs are from fitting the experimental data, each of which is plotted as the mean±standard error of the mean (n=30).

In addition to the y resolution, the x resolution exhibits similar proportional

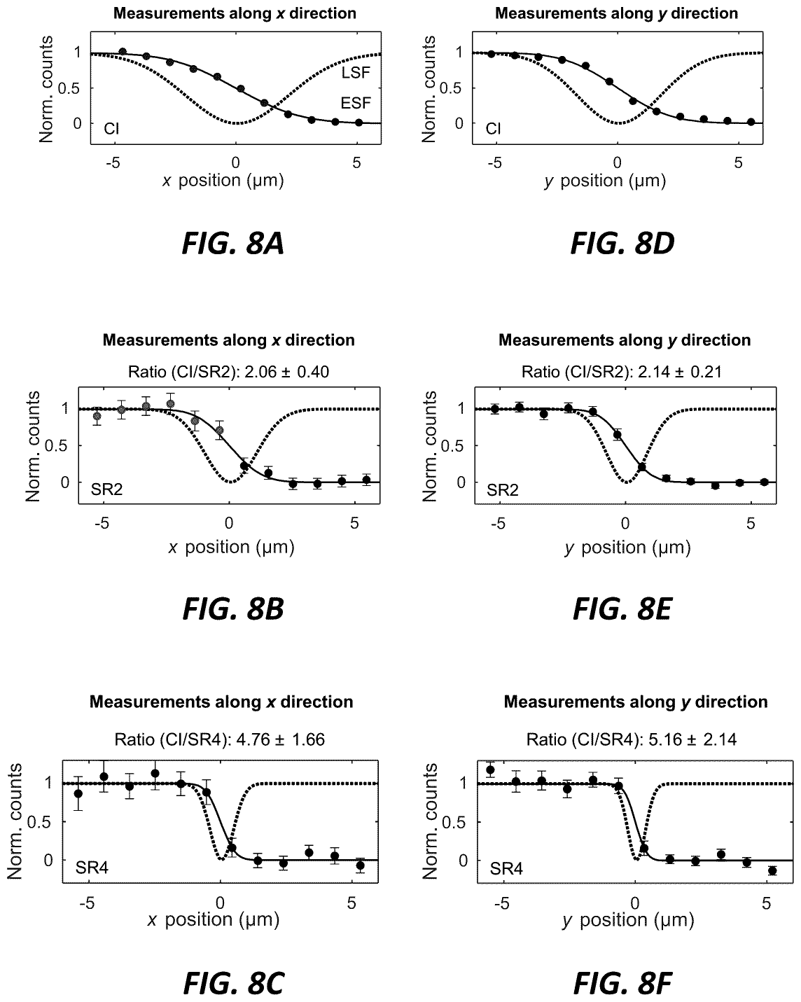

enhancements as shown in FIGS. 8A-8F. FIG. 8A is a plot of the ESR and LSF, along x, of CI images yielded by the HHSQ imaging system 500 in FIG. 5 measured at the z positions marked by the corresponding black circle with white centers in FIG. 7A, according to an implementation. FIG. 8B is a plot of the ESR and LSF, along x, of SR2 images yielded by the HHSQ imaging system 500 in FIG. 5 measured at the z positions marked by the corresponding black circle with white centers in FIG. 7A, according to an implementation. FIG. 8C is a plot of the ESR and LSF, along x, of SR4 images yielded by the HHSQ imaging system 500 in FIG. 5 measured at the z positions marked by the corresponding black circle with white centers in FIG. 7A, according to an implementation. FIG. 8D is a plot of the ESR and LSF, along y, of CI images yielded by the HHSQ imaging system 500 in FIG. 5 measured at the z positions marked by the corresponding black circle with white centers in FIG. 7A, according to an implementation. FIG. 8E is a plot of the ESR and LSF, along y, of SR2 images yielded by the HHSQ imaging system 500 in FIG. 5 measured at the z positions marked by the corresponding black circle with white centers in FIG. 7A, according to an implementation. FIG. 8F is a plot of the ESR and LSF, along y, of SR4 images yielded by the HHSQ imaging system 500 in FIG. 5 measured at the z positions marked by the corresponding black circle with white centers in FIG. 7A, according to an implementation. The ESFs are from fitting the experimental data, each plotted as the mean±standard error of the mean (n=30).

### B. Two-Dimensional Imaging of a USAF Target

The HHSQ imaging system 500 in FIG. 5 was used to image group 3 of the USAF 1951 resolution target (USAF target) for a direct comparison of two-dimensional images of the same structure across the three configurations (CI, SR2, and SR4). Given the field-of-view, the HHSQ imaging system 500 was used to image the number “4” in group 3 of the USAF target.

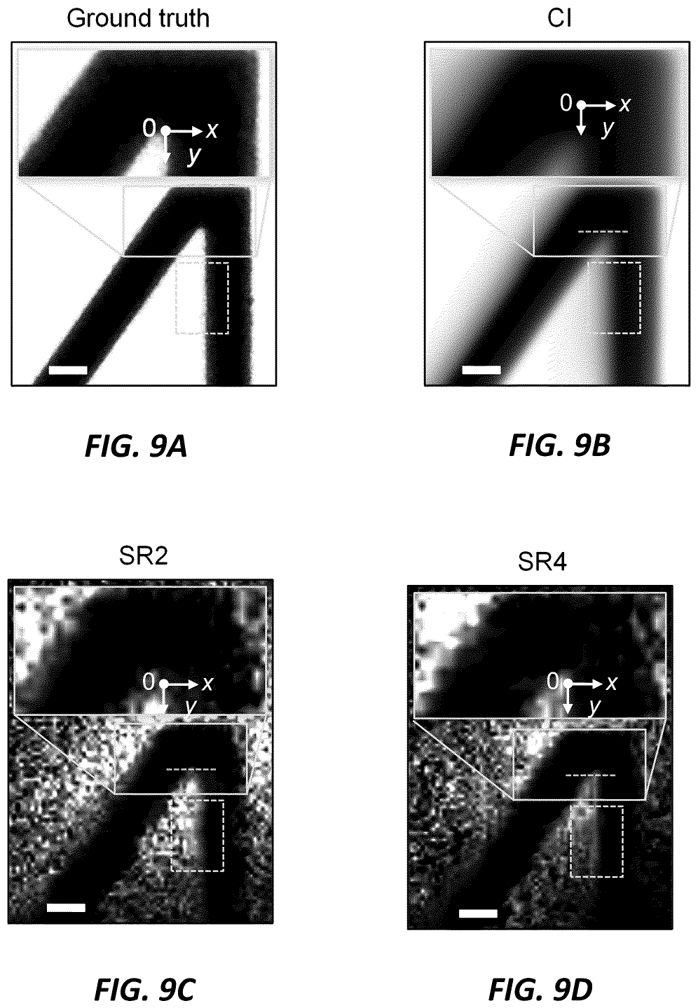

To acquire a ground-truth image, an image of the object was captured using a commercial optical microscope with white light at higher magnification (40×). FIG. 9A is a ground-truth image of the number “4” in group 3 of the USAF 1951 resolution target acquired using white-light optical microscopy under 40× magnification (resolution: 0.50 μm).

The HHSQ imaging system 500 was used to image the same region under CI, SR2, and SR4 configurations. FIG. 9B is an image of the number “4” in group 3 of the USAF 1951 resolution target acquired with the HHSQ imaging system 500 in FIG. 5 using CI imaging, according to an embodiment. FIG. 9C is an image of the number “4” in group 3 of the USAF target acquired with the HHSQ imaging system 500 in FIG. 5 using SR2 imaging, according to an embodiment. FIG. 9D is an image of the number “4” in group 3 of the USAF target acquired with the HHSQ imaging system 500 in FIG. 5 using SR4 imaging, according to an embodiment. The scales are 10 μm. To facilitate a robust comparison, the ground-truth image in FIG. 9A was registered with the CI image in FIG. 9B via similarity translation, leading to alignment of all four images in FIGS. 9A-9D in a shared coordinate system. The origins of the coordinates are determined by the edges along the x and y axes in the ground-truth image.

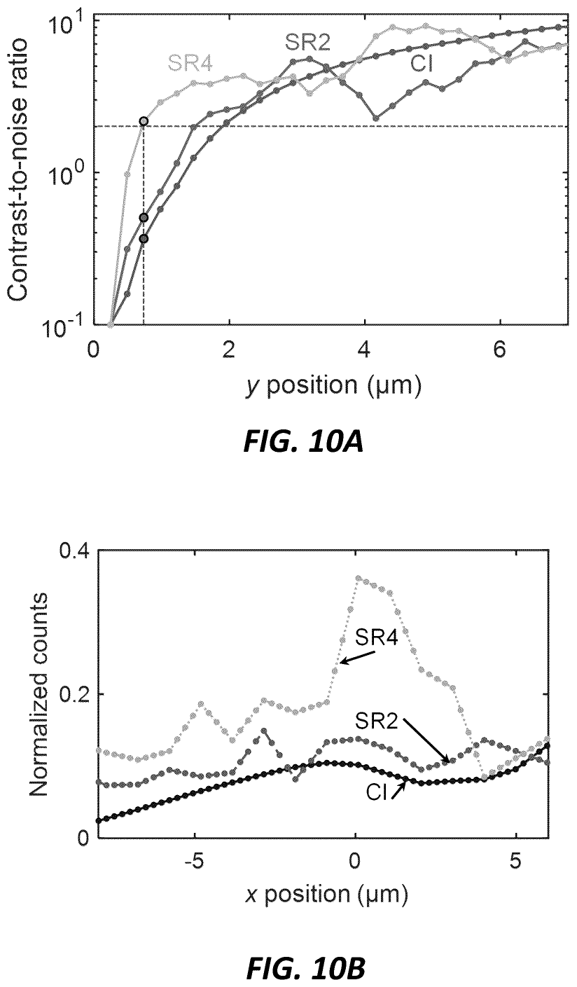

To quantitatively demonstrate the capability of the SR4 setup in resolving finer structures in comparison to SR2 and CI, a region of interest (ROI) was designated within each image in FIGS. 9A-9D. This ROI is displayed as insets in FIGS. 9A-9D. The contrast-to-noise ratios (CNRs) were computed along the x-axis at varying y-positions inside these ROIs. The resultant contrast-to-noise ratios are plotted in FIG. 10A. FIG. 10A is a plot of the contrast-to-noise ratios of the x profiles versus y, where the horizontal dashed line indicates CNR=2, according to embodiments. FIG. 10B is a plot of the normalized CS, SR2, and SR4 counts along the dashed lines in FIGS. 9B, 9C, and 9D, according to embodiments.

As can be seen in FIG. 10A, SR4 shows a steeper ascent of the CNR curve, resolving the cusp of the number “4” better than SR2 and CI. CNR=2 indicated by the horizontal dashed line in FIG. 10A means that the signal of interest can be confidently distinguished from the background at a 98% significance level according to the z test. Pinpointing the y-position where the SR4 curve initially surpasses 2, the x-profiles were charted for all three images as provided in FIG. 10B. A discernible peak proximate to x=0 is solely evident in the SR4 profile, revealing the cusp of the number “4.”

### C. Experimental Data for Classical Imaging without Coincident Detection

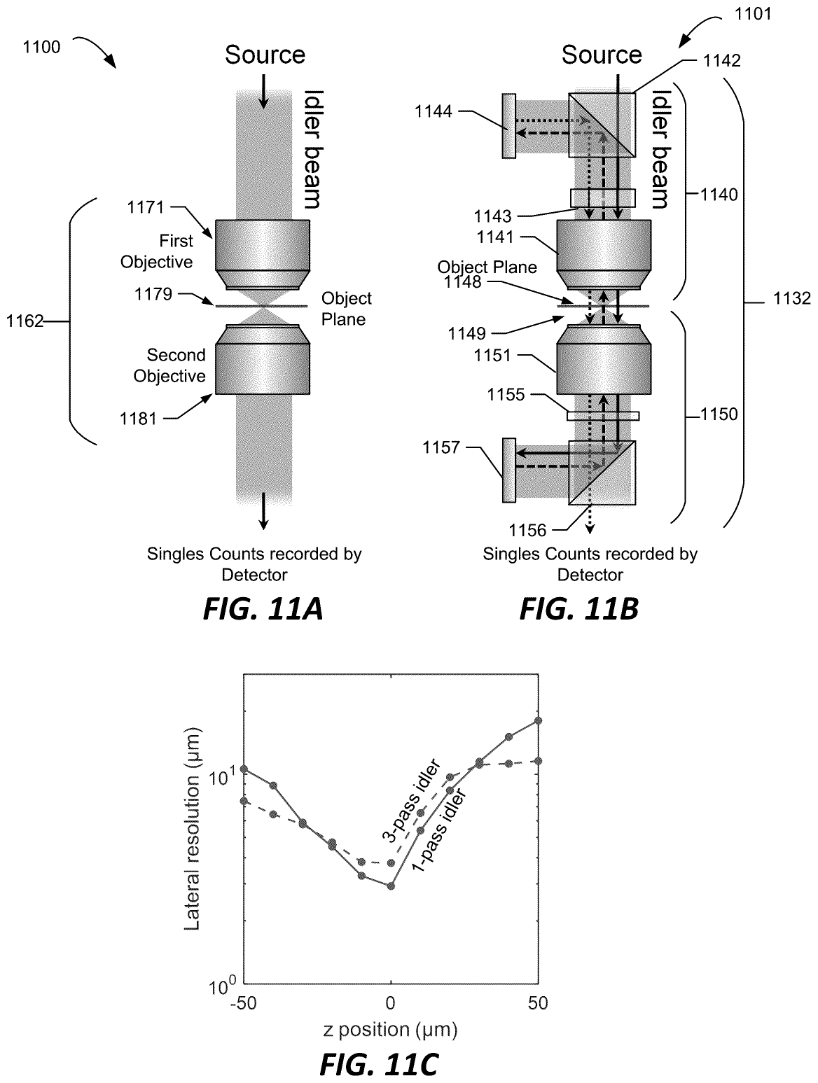

Experimental data was determined for single-pass (i.e. 1-pass) and triple-pass (i.e. 3-pass) idler photons through an idler arm in an imaging system without coincidence detection. FIG. 11A is a schematic drawing of a classical imaging system 1100 without coincidence detection in a single-pass idler arm configuration, according to an implementation. Classical imaging system 1100 includes a single pass idler arm with an optical assembly 1162 having a first objective 1171 and a second objective 1181 and an object plane 1179 therebetween. In this example, the singles counts of photons passing through object plane 1179 can be recorded by a detector (e.g., a CCD sensor).

FIG. 11B is a schematic drawing of a classical imaging system 1101 without

coincidence detection in a triple-pass idler arm configuration, according to an implementation. Classical imaging system 1101 includes a triple pass idler arm. For the purposes of the illustration, the three light paths 1149 of the three passes (triple passes) through the triple-pass idler arm 1130 are shown separated. In actuality, the three light paths 1149 are coincident. The triple-pass idler arm includes a first optical subsystem 1140 and a second optical subsystem 1150. The first optical subsystem 1140 includes a first polarizing beam splitter (PBS) 1142, a Faraday rotator (FR) 1143 for rotating the polarization state non-reciprocally, a first mirror 1144 and a first objective 1141. The second optical subsystem 1150 includes a second objective 1151, a half wave plate (HWP) 1155 for rotating polarization based on a fast axis setting, a second polarizing beam splitter (PBS) 1156 for passing light in a horizontal polarization state, and a second mirror 1157. A object plane 1148 lies between the first and second objectives 1141, 1151. In the illustration, horizontal polarization is designated by a “H,” vertical polarization is designated by a “V,” diagonal polarization is designated by a “D,” and anti-diagonal polarization is designated by an “A.” During operation, idler photons are directed through the idler objective pair 1141, 1151 in the idler arm 1130 three times. In this example, the singles counts of photons passing three times through an object plane 1148 can be recorded by a detector (e.g., a CCD sensor).

During image acquisition, a USAF resolution target is placed at the reference plane as the object being imaged. FIG. 11C is a plot of lateral resolution versus z positions for the single-pass (solid line) and the triple-pass (dashed line) configurations shown in FIGS. 11A and 11B, respectively. As shown in FIG. 11C, while single-pass idler photons alone (e.g., example shown in FIG. 11A) without coincidence detection provide similar CI resolution as signal photons alone, triple-pass idler photons alone (e.g., example shown in FIG. 11B) yield worse CI resolution.

Notwithstanding, the triple-pass configuration in FIG. 11A improves spatial resolution more than single-pass configuration in FIG. 11B through coincidence detection. In the triple-pass configuration, idler photons undergo three passes through the objective lens pair, contrasting with the single-pass configuration. In the triple-pass configuration, the effective NA of the idler arm is constrained by the aperture of the Faraday rotator 1143 in addition to the apertures of the objectives 1141, 1151. Consequently, the lateral resolution is worsened, and the depth of field is lengthened as shown in FIG. 11C. Nevertheless, with coincidence detection, the imaging from the triple-pass configuration (e.g., example shown in FIG. 3) enhances the CI resolution fourfold, while imaging from the single-pass configuration (e.g., example shown in FIG. 2) enhances the CI resolution only twofold.

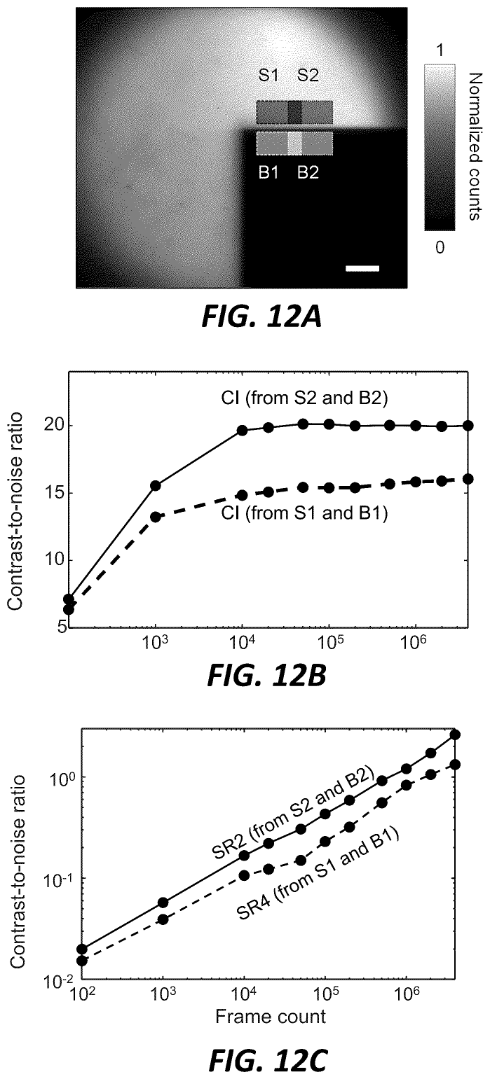

FIG. 12A is a classical image of a corner of a USAF 1951 resolution target based on signal photons detected from the signal arm in FIG. 1. S1 and S2 denote regions selected for signals of interest and B1 and B2 denote regions selected for backgrounds. All regions are sufficiently far away from the edge. Scale bar, 20 μm. FIG. 12B is a plot of CNRs versus frame counts of a plurality of CI images computed for S1 and B1 regions (solid line) and S2 and B2 regions (dashed line). FIG. 12C is a plot of CNRs versus frame counts of (i) the SR2 images computed using S2 and B2 (solid line), where the CNRs of SR2 are the greatest and (ii) the SR4 images computed using S1 and B1 (dashed line), where the CNRs of SR4 are the greatest.

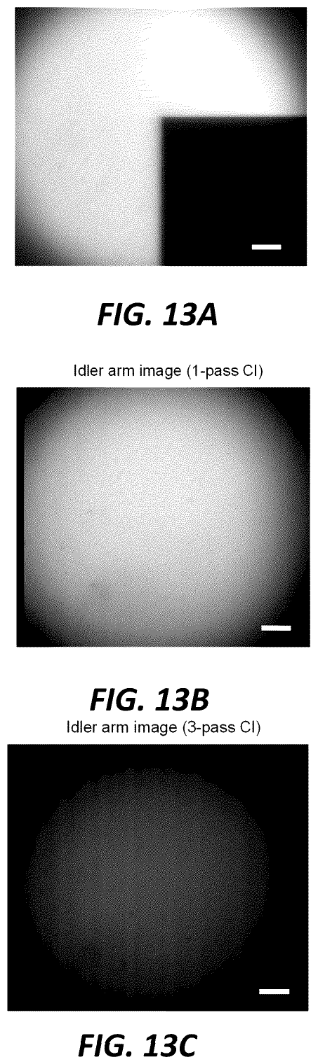

FIG. 13A is a classical image based on signal photons from the signal arm in FIG. 1 with a USAF 1951 resolution target at the object plane 179 for ESF estimation. FIG. 13B is a classical image based on photons from the single-pass idler arm in FIG. 11A with no object at object plane 1179. FIG. 13C is a classical image from the triple-pass idler arm in FIG. 11B with no object at object plane 1148. All images are normalized according to the maximum and minimum of a. Scale bars, 20 μm.

In FIG. 10A, the SR4 configuration with coincidence detection is shown to exhibit higher CNRs than the SR2 and CI configurations near the cusp of the object (e.g., y<3 μm) but lower CNRs further away from the cusp (e.g., y>6 μm). CNR also degrades with reduced numbers of frames as shown in FIGS. 12A-C, which is attributed to the loss of coincidence counts, as evidenced by the different intensities of the single-pass and triple-pass idler beams as shown in FIGS. 13A-C. The loss may be mainly attributed to optical imperfections in the idler arm including non-ideal objective coatings and the limited aperture of the Faraday rotator.

### D. Additional Discussion

The observed resolution enhancement in the experimental data is found consistently in both x and y axes as shown in FIGS. 8A-8F without sacrificing the depth of field along the z-axis. Also, the number of measurements does not appear to affect the resolution. That is, the number of raw image frames used in the experimental data remained the same for the CI, SR2, and SR4 imaging configurations. In fact, the photon counts decrease significantly in the order of CI, SR2, and SR4 and therefore, do not contribute to the resolution enhancement. In addition, the idler arm does not appear to effectively increase the NA through triple-pass coincidence detection in the SR4 configuration. As discussed above with respect to FIGS. 11A-C, the triple-pass idler CI configuration shows worse resolution than the single-pass idler CI.

The phase combination between signal and idler photons having traversed through symmetric optics is shown. By combining the phases from the two arms, the SR2 configuration enhances the CI resolution by a factor of 2. As SR4 accumulates phase in the idler arm three times as much as SR2, SR4 augments the resolution of CI by a factor of 4. As utilizing pairs of entangled photons halves the de Broglie wavelength, the SR2 resolution still adheres to the uncertainty relation based on the reduced wavelength.

The hyper-Heisenberg scaling quantum imaging techniques disclosed herein have been demonstrated to be able to provide quantum super-resolution microscopy beyond the Heisenberg scaling. By directing idler photons through the objective pair in the idler arm thrice and correlating them with the signal photons, classical spatial resolution has been enhanced using a linear imaging system by four times, reaching the hyper-Heisenberg scaling.

### IV. METHODS

### A. Coincidence Estimation

During an example of an image acquisition procedure for an HHSQ system, a detector (e.g., an EMCCD camera) configured for coincident detection takes a plurality of measurements that can be used to reconstruct a plurality of raw images (e.g., a 3D (x-y-t) time-lapsed image stack) of an object or objects. Each raw image (frame) includes two half disks or regions (i.e. based on the beam split by one or more beam-splitting elements).

According to various implementations, an HHSQ imaging method includes a covariance technique to estimate the coincidence intensity of signal and idler photons using the detector. The signal and idler photons are detected by the left and right regions of the detector when viewed along the optical axis, respectively. The distributions of entangled photon pairs in both regions are symmetric about a center point due to their momentum anticorrelation in the far field of the entangled photon source (e.g., BBO crystal); therefore, the left and right images can be inversely registered pixel by pixel according to the symmetric center, r^{c}, which can be determined in a calibration procedure.

The intensities of each pair of two registered pixels in the left (r^{s}, signal) and right (rⁱ, idler) images are given by:

$${I}^{s} ( {i}_{t} ) = {I}_{coin} ( {i}_{t} ) + {I}_{uncorr}^{s} ( {i}_{t} ) , \qquad ( Eqn . 3 )$$

$${I}^{i} ( {i}_{t} ) = {l}_{coin} ( {i}_{t} ) + {I}_{uncorr}^{i} ( {i}_{t} ) , \qquad ( Eqn . 4 )$$

where iₜ denotes the frame index, I_{coin} denotes the reading from the beam responsible for coincidence, I_{uncorr} denotes the reading from other sources such as readout noise that are uncorrelated with I_{coin}, and the superscripts s and i represent the signal and idler arms, respectively.

The mean value of coincidence intensity I̅^̅{̅s̅}̅_̅{̅c̅o̅i̅n̅}̅ is used to estimate the intensity correlation G⁽²⁾. The mean coincidence intensity is estimated by the covariance between I^{s} and Iⁱ, defined by:

$$\overline{{I}_{coin}^{s}} \approx {Cov}_{t} ( {I}^{s} , {I}^{i} ) = \frac{1}{M} {\sum }_{{i}_{t}}^{M} ( {I}^{s} ( {i}_{t} ) - \overline{{I}^{s}} ) ( {I}^{i} ( {i}_{t} ) - \overline{{I}^{i}} ) , \qquad ( Eqn . 5 )$$

where M is the number of frames, and the mean value is computed with respect to time. By applying Eqn. 5 to determine a mean coincidence intensity at each pixel in the field-of-view of the signal (r^{s}) image, a coincidence image can be determined.

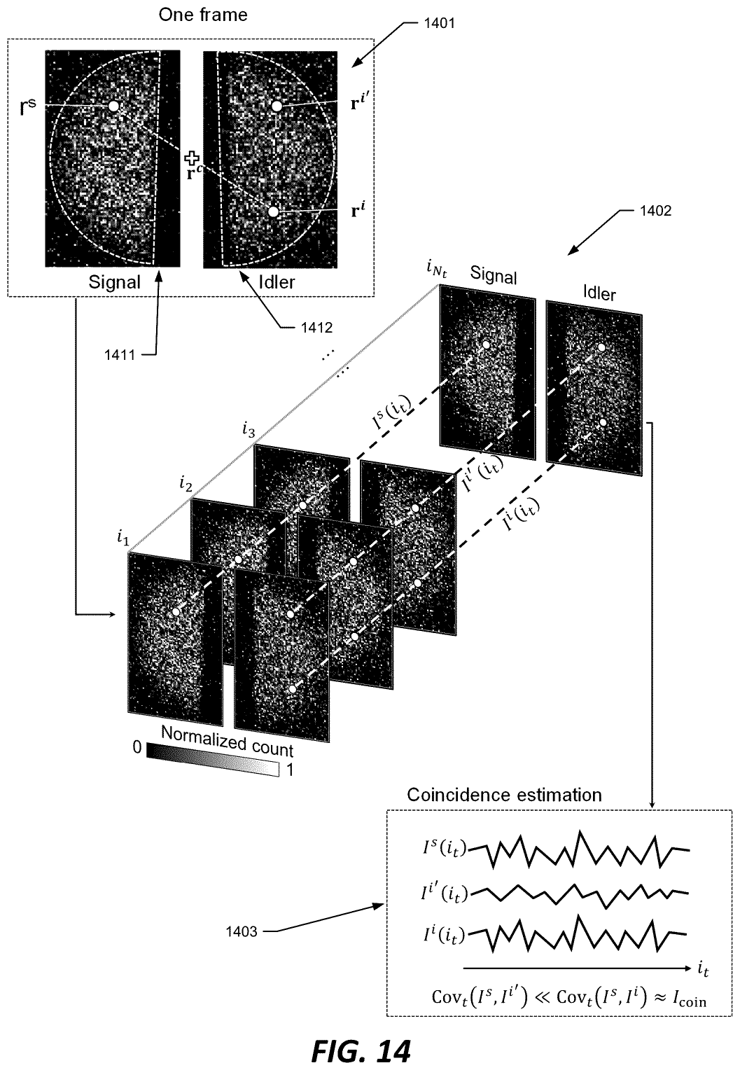

FIG. 14 depicts a schematic representation of the covariance technique, according to an embodiment. The schematic representation includes a single-frame image based on a measurement taken by the detector (e.g., an EMCCD image) of the beam with no object. The beam symmetry center (r^{c}, cross) may be calibrated based on the point-by-point scan of the covariance between the two half disks. Given the point r^{s} in the signal arm, rⁱ is the symmetric point in the idler arm while r^{i′} is another uncorrelated point. The schematic representation also includes a plurality of time-lapsed EMCCD image frames 1402. The EMCCD readings on each pixel form a time sequence I(iₜ) for coincidence estimation. The schematic representation also includes a schematic representation of an example of coincidence estimation. Temporal covariances are computed between the symmetric points as estimations of coincidence counts.

### B. Calibration of the Detector

Prior to acquiring raw images of the object, the detector may be calibrated to estimate the center of the image, r^{c}, (correlation center) from a plurality of frames without an object at the object plane. From the image frames, the correlation center, r^{c}, is estimated through a point-by-point scan over all the pixels and is determined by the pixel that corresponds to the highest overall cross-correlation value.

### C. Normalizing and Denoising

Upon acquiring the coincidence image using a coincidence estimation procedure, the coincidence image intensities may be mapped to the scale of [0,1]. Denoting I as the image intensity, the coincidence images may be normalized using:

$${I}_{norm} = \frac{I - {I}_{min}}{{I}_{max} - {I}_{min}} , \qquad ( Eqn . 6 )$$

where Iₘₐₓ and Iₘᵢₙ are the maximum and minimum values of I. The normalized images may then be denoised using a denoising procedure such as a block-matching 3D filtering (BM3D) procedure. An example of a BM3D procedure can be found in Dabov, K., Foi, A., Katkovnik, V. & Egiazarian, K., “Image Denoising by Sparse 3-D Transform-Domain Collaborative Filtering, IEEE Transactions on Image Processing 16, 2080-2095 (2007).

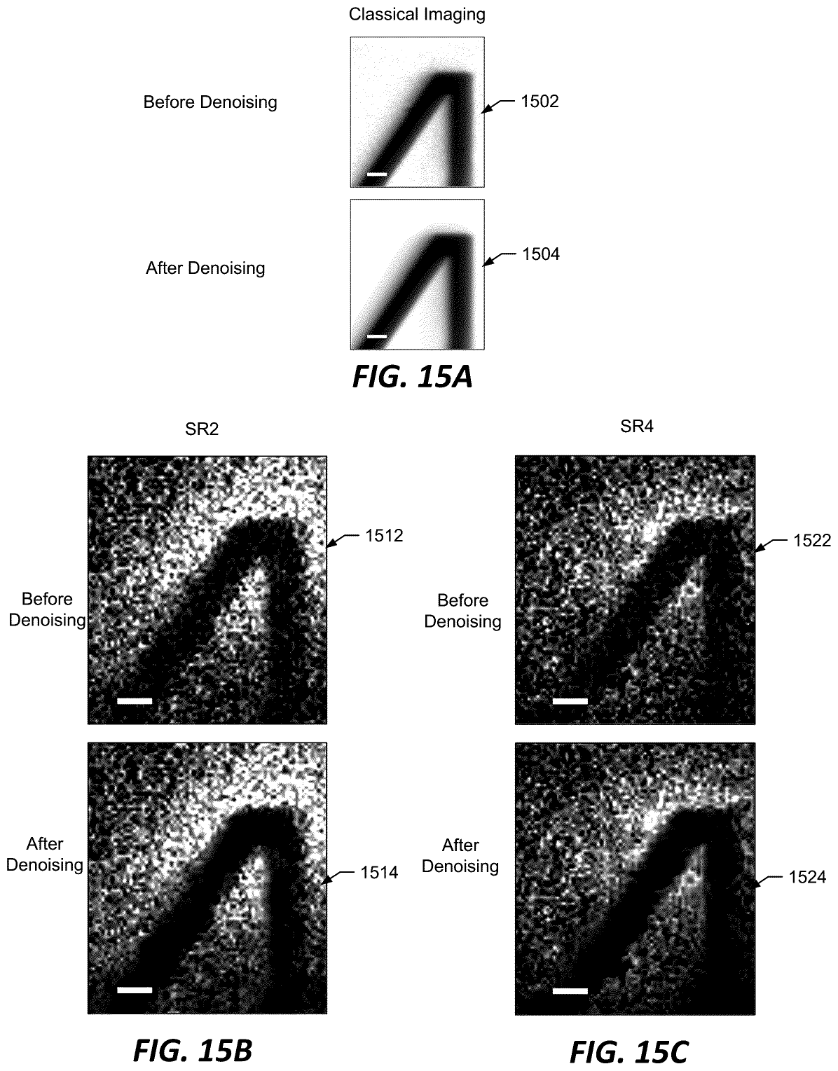

FIGS. 15A-C depicts a comparison of images before and after denoising, according to embodiments. FIG. 15A depicts CI images of the number 4 in a USAF 1951 resolution target before and after denoising, according to embodiments. FIG. 15B depicts SR2 images of the number 4 in a USAF 1951 resolution target before and after denoising, according to embodiments. FIG. 15C depicts SR4 images of the number 4 in a USAF 1951 resolution target before and after denoising, according to embodiments. Scale bars, 10 μm.

### D. Contrast-to-Noise Ratio (CNR) Estimation Method

Denoting Iₛ and I_{b} as the intensities of the target of interest and the background, respectively, the contrast-to-noise ratio (CNR) can be defined as:

$$CNR = \frac{\vert \overline{{I}_{s}} - \overline{{I}_{b}} \vert}{\sqrt{{σ}_{s}^{2} + {σ}_{b}^{2}}} , \qquad ( Eqn . 7 )$$

where I̅ₛ̅ and I̅_̅{̅b̅}̅ are the mean values; σₛ and σ_{b} are the standard deviations of I̅ₛ̅ and I̅_̅{̅b̅}̅.

### E. Methods of Operation

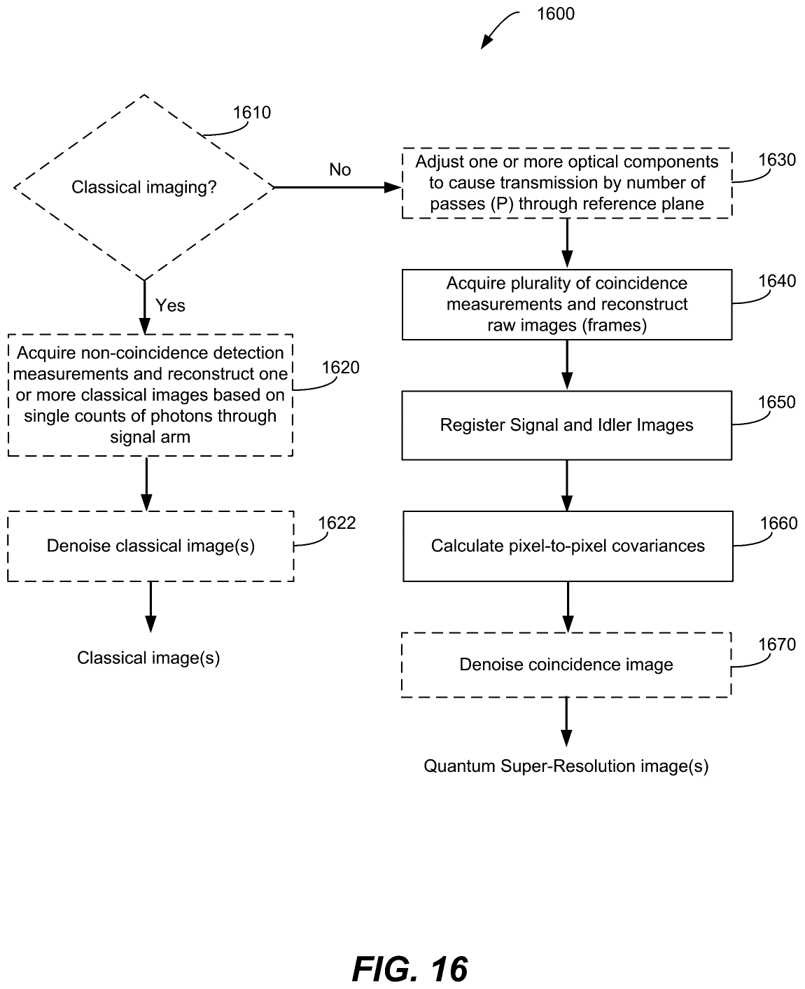

FIG. 16 depicts a flowchart 1600 of a hyper-Heisenberg scaling quantum imaging method, according to various embodiments. The hyper-Heisenberg scaling quantum imaging method may be implemented by a hyper-Heisenberg scaling quantum imaging system such as the hyper-Heisenberg scaling quantum imaging system 400 in FIG. 4 or the hyper-Heisenberg scaling quantum imaging system 400 in FIG. 5.

At optional (denoted by dashed line) operation 1610, it is determined whether the hyper-Heisenberg scaling quantum imaging system is set to perform classical imaging. For example, a controller or the computing device may have a setting that indicates classical imaging is being employed. If classical imaging is not being employed, the Heisenberg scaling quantum imaging system is generally in a super-resolution quantum imaging setting (e.g., an SR2 imaging setting or an SR4 imaging setting). In some aspects, a controller or computing device may have at least three imaging settings. In one aspect, the settings may include a CI imaging setting, an SR2 imaging setting, and an SR4 imaging setting. In another aspect, the settings may include a CI imaging setting, an SR2 imaging setting, an SR4 imaging setting, and/or additional hyper-Heisenberg scaling imaging settings (P=5, 7, etc). In one instance, a user may enter input in an interface of the controller or computing device to change the setting.

If it is determined at operation 1610 that the hyper-Heisenberg scaling quantum imaging system is set to perform CI imaging, the hyper-Heisenberg scaling quantum imaging system operates to acquire one or more CI images based on single counts of photons detected by a detector through the signal arm (optional operation 1620). In this operation, there is no coincidence detection. In one implementation, an entangled photon source is used to generate entangled photon pairs but only one of them is used in the measurements taken by the detector. In another implementation, the HHSQ imaging system includes an additional continuous-wave laser configured to provide a beam with its beam path overlapping the previous signal beam to form the CI image. The one or more CI images may be used as a baseline for comparison with an SR2 image or an SR4 image.

At optional (denoted by dashed line) operation 1622, the quantum one or more CI images may be normalized and denoised. For example, the one or more CI images may be normalized using Eqn. 6. The normalized image or images may then be denoised using a denoising procedure such as a block-matching 3D filtering (BM3D) procedure.

If it is determined at operation 1610 that the hyper-Heisenberg scaling quantum imaging system is set to perform super-resolution quantum imaging, one or more optical components are employed to generate a number of passes (P) of the idler photons through the reference plane in the idler arm (optional operation 1630). A controller or a computing system may send control signals to adjust the optical component(s) or an operator of the system may adjust the optical components. For example, a controller or a computing system may send control signals to a half-wave plate (e.g., half-wave plate 555 in FIG. 5) in the idler arm to set a fast axis setting to employ the number of passes being implemented. For instance, when the fast axis of the half-wave plate is set to 22.5° (π/8) the idler beam may undergo a single pass through the idler objective pair for SR2 imaging to form an SR2 image. In another instance, when the fast axis of the half-wave plate is set to 67.5° (3π/8) the idler beam traverses the idler objective pair thrice for SR4 imaging to yield an SR4 image.

At operation 1640, hyper-Heisenberg scaling quantum imaging system generates a plurality of entangled photon pairs, splits each entangled photon pair into an idler photon passed to an idler arm and a signal photon passed to a signal arm, and passes the idler photon of each entangled photon pair in one or more passes through an idler objective pair. The detector of the hyper-Heisenberg scaling quantum imaging system takes a plurality of coincidence measurements based on arrival times of the entangled photon pairs. The coincidence measurements are used to reconstruct a plurality of raw images (frames) such as, for example, a 3D (x-y-t) time-lapsed image stack. Various numbers of frames may be reconstructed. In one implementation, the number of frames reconstructed is in a range of 1 million to 4 million. Each raw image (frame) includes two half disks (e.g., left signal image and right idler image) or regions (i.e. the beam split by one or more beam-splitting elements). FIG. 14 depicts an example of a frame 1401 including a left signal image 1411 and a right idler image 1412.

At operation 1650, the signal and idler images of each frame are registered according to a correlation center, r^{c}. As shown in FIG. 14, the signal and idler images are central symmetric about the correlation center, r^{c}. Since these images are central symmetric, the images are registered by at least flipping one of the images (e.g., the signal image) by 180 degrees about the correlation center, r^{c} before calculating pixel-to-pixel covariances at operation 1660. The correlation center, r^{c}, can be determined by the calibration procedure such as discussed in Section IV(B). For example, the detector may take coincidence measurements without an object at the object plane. From image frames reconstructed from the coincidence measurements, the correlation center, r^{c}, may be estimated through a point-by-point scan over all the pixels and is determined by the pixel that corresponds to the highest overall cross-correlation value. In one implementation, the method further includes the calibration procedure as an operation performed before operation 1650.

At operation 1660, the pixel-to-pixel covariances are calculated. At this operation, a mean coincidence intensity is estimated at each pixel in the field-of-view of the signal image for the plurality of frames using the covariance technique discussed in Section IV. For example, Eqn. 5 may be applied at each pixel in the field-of-view of the signal image to determine a mean coincidence intensity value at each pixel and the values at the pixels are combined to generate a quantum super-resolution image (sometimes referred to herein as a “coincidence image”). If the number of passes through the reference plane is three or more, the quantum super-resolution image generated is a hyper-Heisenberg scaling quantum image. If there is a single pass through the reference plane, the quantum super-resolution image generated is a Heisenberg scaling quantum image. The quantum super-resolution image may have an estimated enhanced resolution based on the number of passes implemented as provided in Eqns. 1 and 2.

At optional (denoted by dashed line) operation 1670, the quantum super-resolution image intensities may be normalized and the normalized image denoised. For example, the coincidence image may be normalized using Eqn. 6. The normalized image may then be denoised using a denoising procedure such as a block-matching 3D filtering (BM3D) procedure.

Although operations 1640-1660 are described as generating a single quantum super-resolution image, in another implementation, operations 1640-1660 may be performed on multiple sets of two or more frames of the plurality of frames to generate multiple super-resolution images.

### V. Computing Device Subsystems

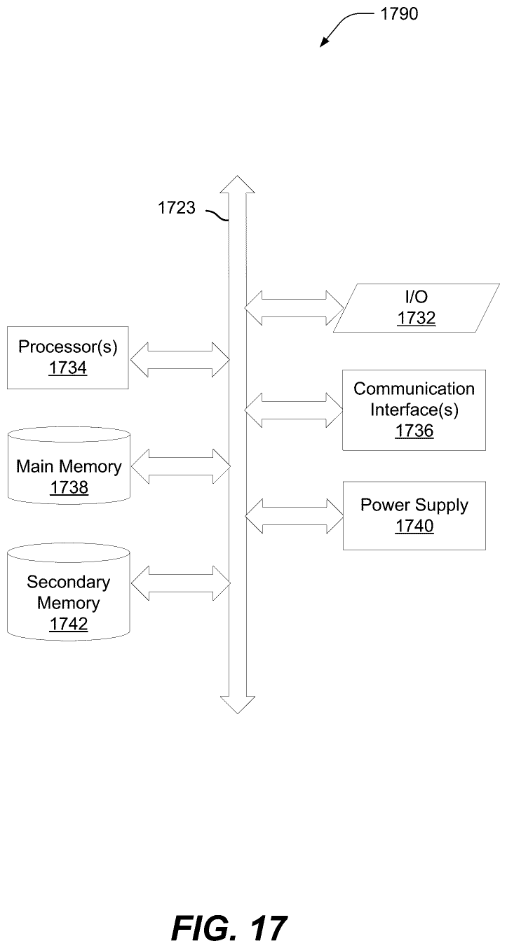

FIG. 17 depicts components of a computing device 1722, according to embodiments. In one implementation, the computing device 493 in FIG. 4 includes one or more of the components of the computing device 1722 in FIG. 17. In various examples, computing device 1722 is in electrical communication with a detector (e.g., detector 490 in FIG. 4) to receive signals with image data. In some cases, the computing device 1722 may also send control signals to one or more system components to control functions of the HHSQ imaging system. Communication between components of computing device 1722 may be in wireless and/or wired form.

In FIG. 17, computing device 1722 includes a bus 1723 coupled to an input/output (I/O) subsystem 1732, one or more processors 1734, one or more communication interfaces 1736, a main memory 1738, a secondary memory 1742, and a power supply 1740. One of more of these components may be in separate housing.

I/O subsystem 1732, includes, or is in communication with, one or more components, which may implement an interface for interacting with human users and/or other computer devices depending upon the application. Certain embodiments disclosed herein may be implemented in program code on computing device 1722 with I/O subsystem 1732 used to receive input program statements and/or data from a human user (e.g., via a graphical user interface (GUI), a keyboard, touchpad, etc.) and to display them back to the user, for example, on a display. The I/O subsystem 1732 may include, e.g., a keyboard, mouse, graphical user interface, touchscreen, or other interfaces for input, and, e.g., an LED or other flat screen display, or other interfaces for output. Other elements of embodiments may be implemented with a computer device like that of computing device 1722 without I/O subsystem 1732. According to various embodiments, the one or more processors 1734 may include a CPU, GPU or computer, analog and/or digital input/output connections, controller boards, etc.

Program code may be stored in non-transitory computer readable media such as secondary memory 1742 or main memory 1738 or both. The one or more processors 1734 may read program code from one or more non-transitory media and execute the code to enable computing device 1722 to accomplish the methods performed by various embodiments described herein. Those skilled in the art will understand that the one or more processors 1734 may accept source code and interpret or compile the source code into machine code that is understandable at the hardware gate level of the one or more processors 1734.

Communication interfaces 1736 may include any suitable components or circuitry used for communication using any suitable communication network (e.g., the Internet, an intranet, a wide-area network (WAN), a local-area network (LAN), a wireless network, a virtual private network (VPN), and/or any other suitable type of communication network). For example, communication interfaces 1736 can include network interface card circuitry, wireless communication circuitry, etc.

In certain embodiments, computing device 1722 may be part of or connected to a controller (e.g., controller 498 in FIG. 4) that is employed to control functions of HHSQ imaging system such as, e.g., adjusting the fast axis of a HWP to switch between SR2 and SR4 imaging or to using only signal photons in CR imaging. The controller will typically include one or more memory devices and one or more processors. The processor may include a CPU or computer, analog and/or digital input/output connections, stepper motor controller boards, etc.

Modifications, additions, or omissions may be made to any of the above-described embodiments without departing from the scope of the disclosure. Any of the embodiments described above may include more, fewer, or other features without departing from the scope of the disclosure. Additionally, the steps of described features may be performed in any suitable order without departing from the scope of the disclosure. Also, one or more features from any embodiment may be combined with one or more features of any other embodiment without departing from the scope of the disclosure. The components of any embodiment may be integrated or separated according to particular needs without departing from the scope of the disclosure.

It should be understood that certain aspects described above can be implemented in the form of logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code using any suitable computer language and/or computational software such as, for example, Java, C, C #, C++ or Python, Matlab, or other suitable language/computational software, including low level code, including code written for field programmable gate arrays, for example in VHDL; embedded artificial intelligence computing platform, for example in Jetson. The code may include software libraries for functions like data acquisition and control, motion control, image acquisition and display, etc. Some or all of the code may also run on a personal computer, single board computer, embedded controller, microcontroller, digital signal processor, field programmable gate array and/or any combination thereof or any similar computation device and/or logic device(s). The software code may be stored as a series of instructions, or commands on a CRM such as a random-access memory (RAM), a read only memory (ROM), a magnetic media such as a hard-drive or a floppy disk, or an optical media such as a CD-ROM, or solid stage storage such as a solid state hard drive or removable flash memory device or any suitable storage device. Any such CRM may reside on or within a single computational apparatus, and may be present on or within different computational apparatuses within a system or network. Although the foregoing disclosed embodiments have been described in some detail to facilitate understanding, the described embodiments are to be considered illustrative and not limiting. It will be apparent to one of ordinary skill in the art that certain changes and modifications can be practiced within the scope of the appended claims.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

What is claimed is:

1. A hyper-Heisenberg scaling quantum imaging system, comprising:
an entangled photon source configured to generate a plurality of entangled photon pairs, each entangled photon pair split into an idler into an idler photon and a signal photon;
an idler arm optical assembly configured to pass the idler photon of each entangled photon pair in one or more passes through an idler objective pair;
a signal arm optical assembly configured to pass the signal photon of each entangled photon pair at least once through an object plane of a signal objective pair; and
a detector configured for coincidence detection of the idler photon and signal photon of each entangled photon pair to acquire a plurality of coincidence measurements.

2. The hyper-Heisenberg scaling quantum imaging system of claim 1, further comprising one or more beam-splitting elements configured to split each entangled photon pair into the idler photon and the signal photon.

3. The hyper-Heisenberg scaling quantum imaging system of claim 1, wherein the idler objective pair is identical to the signal objective pair.

4. The hyper-Heisenberg scaling quantum imaging system of claim 1, wherein the hyper-Heisenberg scaling quantum imaging system is configured to use the plurality of coincidence measurements to yield one or more coincidence images with a spatial resolution of up to four times a spatial resolution of a classical image acquired by a classical imaging system with an equivalent signal objective pair.

5. The hyper-Heisenberg scaling quantum imaging system of claim 1, wherein the idler arm optical assembly and signal arm optical assembly are optically symmetric.

6. The hyper-Heisenberg scaling quantum imaging system of claim 1, wherein optical paths of the signal photon and the idler photon between a source Fourier plane and a detection plane at the detector have equivalent optical pathlengths and magnification ratios.

7. The hyper-Heisenberg scaling quantum imaging system of claim 1, wherein the entangled photon source comprises a spontaneous parametric down-conversion source.

8. The hyper-Heisenberg scaling quantum imaging system of claim 7, wherein the spontaneous parametric down-conversion source comprises a β-barium borate crystal or a periodically poled potassium titanyl phosphate crystal.

9. The hyper-Heisenberg scaling quantum imaging system of claim 1, wherein the detector is an electron multiplying charge-coupled device.

10. The hyper-Heisenberg scaling quantum imaging system of claim 1, wherein the one or more beam-splitting elements comprises a prism.

11. The hyper-Heisenberg scaling quantum imaging system of claim 10, wherein the prism comprises a right-angle prism mirror.

12. The hyper-Heisenberg scaling quantum imaging system of claim 1, wherein the detector is a single detector or a detector array.

13. The hyper-Heisenberg scaling quantum imaging system of claim 1, wherein the detector comprises a single-photon counting detector or a superconducting nanowire single-photon detector.

14. The hyper-Heisenberg scaling quantum imaging system of claim 1, wherein the idler arm optical assembly further comprises one or more optical elements configured to adjust the one or more passes through the idler objective pair.

15. The hyper-Heisenberg scaling quantum imaging system of claim 14, wherein the one or more optical elements comprise a half-wave plate or a Kerr gate.

16. The hyper-Heisenberg scaling quantum imaging system of claim 1, further comprising:
a controller; and
a half-wave plate in the idler arm optical assembly, the half-wave plate in electrical communication with the controller, wherein the controller is configured to send one or more control signals to the half-wave plate to adjust the one or more passes.

17. The hyper-Heisenberg scaling quantum imaging system of claim 1, wherein:
the idler arm optical assembly is configured to pass the idler photon of each entangled photon pair in a plurality of passes through the idler objective pair; and
the hyper-Heisenberg scaling quantum imaging system is configured to use the plurality of coincidence measurements to yield one or more coincidence images at hyper-Heisenberg scaling.

18. The hyper-Heisenberg scaling quantum imaging system of claim 1,
wherein the idler arm optical assembly is configured to pass the idler photon of each entangled photon pair in a plurality of passes through the idler objective pair; and
further comprising a computing device configured to execute instructions to use the plurality of coincidence measurements to yield one or more coincidence images at hyper-Heisenberg scaling.

19. A hyper-Heisenberg scaling quantum imaging method comprising:
generating a plurality of entangled photon pairs;
splitting each entangled photon pair into an idler photon and a signal photon;
passing the idler photon of each entangled photon pair in one or more passes through an idler objective pair;
passing the signal photon of each entangled photon pair at least once through a signal objective pair;
taking a plurality of coincidence measurements based on coincidence detection of signal photons from the signal arm and idler photons from the idler arm; and
determining a coincidence image based on the plurality of coincidence measurements.

20. The hyper-Heisenberg scaling quantum imaging method of claim 19, further comprising:
reconstructing a plurality of frames from the plurality of coincidence measurements;
registering a signal image and an idler image of each frame;
calculating pixel-to-pixel covariances of the registered signal image of each of the plurality of frames; and
determining the coincidence image from the pixel-to-pixel covariances.

21. The hyper-Heisenberg scaling quantum imaging method of claim 20, wherein calculating the pixel-to-pixel covariances comprises calculating a mean coincidence intensity pixel value at each pixel of the registered signal image of each frame using a covariance procedure.

22. The hyper-Heisenberg scaling quantum imaging method of claim 21, wherein determining the coincidence image comprises
combining the mean coincidence intensity pixel values to form a quantum super-resolution image.

23. The hyper-Heisenberg scaling quantum imaging method of claim 19, further comprising denoising the coincidence image.

24. The hyper-Heisenberg scaling quantum imaging method of claim 19, further comprising:
detecting only signal photons without coincidence detection to take a plurality of measurements; and
generating one or more classical images from the plurality of measurements.

25. The hyper-Heisenberg scaling quantum imaging method of claim 19, further comprising adjusting one or more optical components to pass the idler photon of each entangled photon pair in one or more passes through an idler objective pair.

26. The hyper-Heisenberg scaling quantum imaging method of claim 19, further comprising adjusting a fast axis of a half-wave plate to pass the idler photon of each entangled photon pair in a plurality of passes through an idler objective pair, wherein the coincidence image generated is a hyper-Heisenberg scaling quantum image.

27. The hyper-Heisenberg scaling quantum imaging method of claim 19, further comprising setting the quantum super-resolution imaging system to pass the idler photon of each entangled photon pair in (i) a single pass through the idler objective pair or (ii) a triple pass through the idler objective pair.

28. A hyper-Heisenberg scaling quantum imaging method comprising:
causing generation of a plurality of entangled photon pairs, wherein each entangled photon pair is split into an idler photon and a signal photon;
causing an idler photon of each entangled photon pair to be transmitted in one or more passes through an idler objective pair, wherein the signal photon of each entangled photon pair is transmitted at least once through a signal objective pair;
taking a plurality of coincidence measurements based on coincidence detection of signal photons from the signal arm and idler photons from the idler arm; and
determining a coincidence image based on the plurality of coincidence measurements.

29. The hyper-Heisenberg scaling quantum imaging method of claim 28, further comprising:
reconstructing a plurality of frames from the plurality of coincidence measurements;
registering a signal image and an idler image of each frame;
calculating pixel-to-pixel covariances of the registered signal image of each of the plurality of frames; and
determining the coincidence image from the pixel-to-pixel covariances.
